(19) United States
(12) Patent Application Publication
(10) Pub. No.: US 2025/0031155 A1
(43) Pub. Date: Jan. 23, 2025

(54) MULTIPLE POWER HEADROOM REPORT FOR MULTIPLE TRANSMISSION RECEPTION POINT SCENARIOS WITH SIMULTANEOUS TRANSMISSIONS

(71) Applicant: QUALCOMM Incorporated, San Diego, CA (US)

(72) Inventors: Fang YUAN, Beijing (CN); Wooseok NAM, San Diego, CA (US); Yan ZHOU, San Diego, CA (US); Mostafa KHOSHNEVISAN, San Diego, CA (US); Jelena DAMNJANOVIC, Del Mar, CA (US); Jing SUN, San Diego, CA (US); Tao LUO, San Diego, CA (US); Junyi LI, Greentown, PA (US)

(21) Appl. No.: 18/713,039

(22) PCT Filed: Jan. 24, 2022
(86) PCT No.: PCT/CN2022/073375

§ 371 Date: May 23, 2024

(51) Int. Cl. H04W 52/36; H04W 72/044; H04W 72/21

(52) U.S. Cl. CPC H04W 52/365; H04W 72/044; H04W 72/21

(57) ABSTRACT

Various aspects of the present disclosure generally relate to wireless communication. In some aspects, a user equipment (UE) may receive a configuration for a component carrier (CC) configuring the CC for simultaneous transmissions associated with multiple transmission reception points (TRPs). The UE may transmit a power headroom (PHR) report, associated with the CC, that indicates: a first PHR value associated with a first TRP associated with the multiple TRPs (mTRPs) and a second PHR value associated with a second TRP associated with the mTRPs; or a single PHR value associated with at least one of the first TRP or the second TRP. Numerous other aspects are provided.

### FIELD OF THE DISCLOSURE

Aspects of the present disclosure generally relate to wireless communication and specifically, to techniques and apparatuses for multiple power headroom (PHR) value reporting for multiple transmission reception point (TRP) scenarios with simultaneous transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

Power headroom (PHR) may indicate an amount of remaining transmission power available to a user equipment (UE) in addition to power being used by a current transmission. The PHR may be based at least in part on a difference between a UE maximum transmission power and a physical uplink shared channel (PUSCH) transmission power. In some examples, a PHR value may be an actual PHR value (for example, that is calculated based at least in part on an actual transmission) or a virtual PHR value (for example, that is not associated with an actual transmission and that is estimated by the UE based at least in part on default power control parameters configured by a base station or a transmission reception point (TRP)). In some examples, a UE may support PHR reporting in multiple-TRP (mTRP) scenarios. In some cases, for PHR reporting related to mTRP PUSCH repetitions, a UE may report two or more PHR values. The PHR values may be respectively associated with a first PUSCH occasion for each TRP (for example, each TRP associated with the mTRP scenario) in a slot for a component carrier (for example, a component carrier that is configured for the mTRP communications). In other words, for mTRP PUSCH repetitions, the UE may transmit two PHR values, corresponding to two TRPs, in a single PHR medium access control (MAC) control element (MAC-CE).

In some examples, when a PHR report is transmitted in a slot n, if a first PHR value associated with a first TRP is an actual PHR corresponding to a repetition among multiple mTRP PUSCH repetitions associated with the first TRP, then the second PHR value may be an actual PHR value if a repetition associated with a second TRP is transmitted in slot n. If there are multiple repetitions associated with the second TRP in the slot n, then the repetition that occurs earliest in the time domain in slot n may be selected by the UE to calculate the second PHR value. However, in some cases, mTRP scenarios may be associated with simultaneous transmissions (for example, two or more transmission that at least partially overlap in the time domain). For example, in some cases, the simultaneous transmissions may begin at the same time (such as at the same symbol). However, signaling and coordination for PHR reporting associated with mTRP simultaneous transmissions is not defined (for example, by a wireless communication standard). For example, in cases where the simultaneous transmissions begin at the same time, or approximately the same time, there may be a lack of coordination between a UE and TRPs (or base stations) as to which transmission is to be considered a “first” transmission for purposes of calculating and reporting PHR values for the multiple TRPs. Additionally, some UEs may not support transmitting a PHR report that includes multiple PHR values that correspond to different respective TRPs. In such examples, coordination as to which transmission, among the simultaneous transmissions, is to be used to calculate a PHR value to be reported by the UE may not be defined. As a result, a TRP (or a base station) may incorrectly interpret a PHR report transmitted by the UE. For example, a TRP may incorrectly interpret a PHR value included in the PHR report as being associated with the TRP when the PHR value is actually associated with another TRP in an mTRP scenario (for example, because of the lack of coordination between the UE and the TRPs).

### SUMMARY

Some aspects described herein relate to a user equipment (UE) for wireless communication. The user equipment may include at least one processor and at least one memory, communicatively coupled with the at least one processor, that stores processor-readable code. The processor-readable code, when executed by the at least one processor, may be configured to cause the user equipment to receive a configuration for a component carrier (CC) configuring the CC for simultaneous transmissions associated with multiple transmission reception points (TRPs). The processor-readable code, when executed by the at least one processor, may be configured to cause the user equipment to transmit a power headroom (PHR) report, associated with the CC, that indicates: a first PHR value associated with a first TRP associated with the multiple TRPs (mTRPs) and a second PHR value associated with a second TRP associated with the mTRPs; or a single PHR value associated with at least one of the first TRP or the second TRP.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit, to a UE, a configuration for a CC configuring the CC for simultaneous transmissions associated with mTRPs. The processor-readable code, when executed by the at least one processor, may be configured to cause the network node to receive, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP.

Some aspects described herein relate to a method of wireless communication performed by a UE. The method may include receiving a configuration for a CC configuring the CC for simultaneous transmissions associated with mTRPs. The method may include transmitting a PHR report, associated with the CC, that indicates, a first PHR value associated with a first TRP associated with the mTRPs and a second PHR value associated with a second TRP associated with the mTRPs or; a single PHR value associated with at least one of the first TRP or the second TRP.

Some aspects described herein relate to a method of wireless communication performed by a network node. The method may include transmitting, to a UE, a configuration for a CC configuring the CC for simultaneous transmissions associated with mTRPs. The method may include receiving, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP.

Some aspects described herein relate to a non-transitory computer-readable medium that stores a set of instructions for wireless communication by a UE. The set of instructions, when executed by one or more processors of the UE, may cause the UE to receive a configuration for a CC configuring the CC for simultaneous transmissions associated with mTRPs. The set of instructions, when executed by one or more processors of the UE, may cause the UE to transmit a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP.

Some aspects described herein relate to a non-transitory computer-readable medium that stores a set of instructions for wireless communication by a network node. The set of instructions, when executed by one or more processors of the network node, may cause the network node to transmit, to a UE, a configuration for a CC configuring the CC for simultaneous transmissions associated with mTRPs. The set of instructions, when executed by one or more processors of the network node, may cause the network node to receive, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP.

Some aspects described herein relate to an apparatus for wireless communication. The apparatus may include means for receiving a configuration for a CC configuring the CC for simultaneous transmissions associated with mTRPs. The apparatus may include means for transmitting a PHR report, associated with the CC, that indicates: a first PHR value associated with a first TRP associated with mTRPs and a second PHR value associated with a second TRP associated with the mTRPs; or a single PHR value associated with at least one of the first TRP or the second TRP.

Some aspects described herein relate to an apparatus for wireless communication. The apparatus may include means for transmitting, to a UE, a configuration for a CC configuring the CC for simultaneous transmissions associated with mTRPs. The apparatus may include means for receiving, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 illustrates an example logical architecture of a distributed radio access network (RAN), in accordance with the present disclosure.

FIG. 4 is a diagram illustrating an example of multiple transmission reception point (TRP) communication, in accordance with the present disclosure.

FIG. 5 is a diagram illustrating examples of carrier aggregation, in accordance with the present disclosure.

FIG. 6 is a diagram illustrating examples of simultaneous transmissions, in accordance with the present disclosure.

FIG. 7 is a diagram illustrating an example of power headroom (PHR) reporting, in accordance with the present disclosure.

FIG. 8 is a diagram of an example associated with a multiple PHR value reporting for multiple TRP (mTRP) scenarios with simultaneous transmissions, in accordance with the present disclosure.

FIG. 9 is a diagram of an example associated with physical uplink shared channel (PUSCH) occasions associated with PHR reports for mTRP scenarios with simultaneous transmissions, in accordance with the present disclosure.

FIG. 10 is a flowchart illustrating an example process performed, for example, by a UE, associated with a multiple PHR value reporting for mTRP scenarios with simultaneous transmissions, in accordance with the present disclosure.

FIG. 11 is a flowchart illustrating an example process performed, for example, by a network node, associated with a multiple PHR value reporting for mTRP scenarios with simultaneous transmissions, in accordance with the present disclosure.

FIG. 12 is a diagram of an example apparatus for wireless communication in accordance with the present disclosure.

FIG. 13 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to power headroom (PHR) reporting for multiple transmission reception point (TRP) scenarios with simultaneous transmissions. Some aspects more specifically relate to PHR reports that each include multiple PHR values corresponding to different TRPs for multiple-TRP (mTRP) scenarios with simultaneous transmissions. In some aspects, a user equipment (UE) may receive a configuration for a component carrier (CC) configuring the CC for simultaneous transmissions associated with mTRP operations. The UE may transmit a PHR report associated with the CC. In some aspects, the PHR report may indicate a first PHR value associated with a first TRP associated with the mTRP operations and a second PHR value associated with a second TRP of the mTRP operations. For example, the PHR report may include multiple PHR values corresponding to respective TRPs of the mTRP operations. In some aspects, the PHR report may indicate the first PHR value and the second PHR value based at least in part on the UE being capable of transmitting PHR reports that indicate multiple PHR values.

In some other aspects, the PHR report may indicate a single PHR value associated with the mTRP operations. For example, the PHR report may indicate the single PHR value based at least in part on the UE not being capable of transmitting PHR reports that indicate multiple PHR values. In some aspects, the UE may identify a physical uplink shared channel (PUSCH) occasion (for example, from multiple PUSCH occasions associated with the simultaneous transmissions) to be used to calculate the single PHR value (or a first PUSCH occasion, to be associated with a first PHR value, when the PHR report indicates the first PHR value and a second PHR value) based at least in part on one or more rules. In some aspects, the one or more rules may be based at least in part on sounding reference signal (SRS) resource set identifiers associated with the multiple PUSCH occasions, transmission configuration indicator (TCI) state identifiers associated with the multiple PUSCH occasions, closed loop index values associated with the multiple PUSCH occasions, an order of the multiple PUSCH occasions as indicated by dynamic switching indicator or TCI states included in a downlink control information (DCI) message that schedules the multiple PUSCH occasions, frequency domain resource allocations associated with the multiple PUSCH occasions, demodulation reference signal (DMRS) code division multiplex (CDM) group identifiers associated with the multiple PUSCH occasions, or control resource set (CORESET) pool index values associated with the multiple PUSCH occasions, among other examples.

Particular aspects of the subject matter described in this disclosure can be implemented to realize one or more of the following potential advantages. In some examples, the described techniques can be used to enable a UE to transmit a PHR report that includes multiple PHR values when a CC is configured to enable simultaneous transmissions associated with mTRP operations. In some aspects, the described techniques can be used to enable coordination between a UE and TRPs (or base stations) for PHR reporting when a CC is configured to enable simultaneous transmissions associated with mTRP operations. As a result, a TRP (or a base station) may be enabled to correctly interpret the PHR report and associate a PHR value included in the PHR report with the correct TRP or PUSCH occasion.

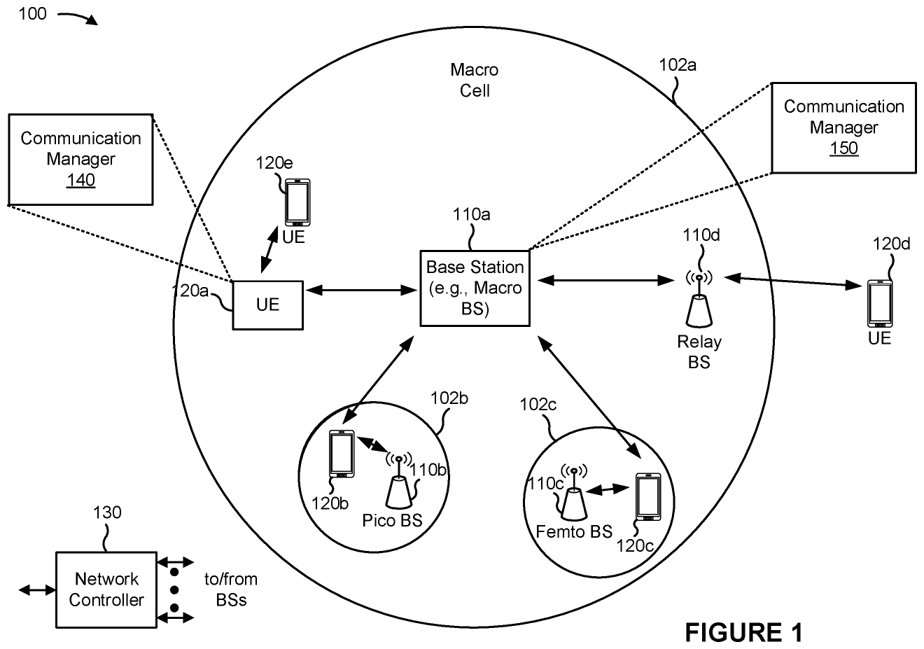

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a TRP. Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). Although a portion of FR1 is greater than 6 GHZ, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

As described herein, a node, which may be referred to as a “node,” a “network node,” or a “wireless node,” may be a base station (for example, base station 110), a UE (for example, UE 120), a relay device, a network controller, an apparatus, a device, a computing system, one or more components of any of these, or another processing entity configured to perform one or more aspects of the techniques described herein. For example, a network node may be a UE. As another example, a network node may be a base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (for example, a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, or a second processing entity, among other examples.

In some examples, the term “base station” (for example, the base station 110) may refer to an aggregated base station, a disaggregated base station, or one or more components of a disaggregated base station. For example, in some examples, “base station” may refer to a control unit, a distributed unit, a radio unit, a plurality of control units, a plurality of distributed units, a plurality of radio units, or a combination thereof. In some examples, “base station” may refer to one device configured to perform one or more functions such as those described herein in connection with the base station 110. In some examples, “base station” may refer to a plurality of devices configured to perform the one or more functions. For example, in some distributed systems, different devices (which may be located in the same geographic location or in different geographic locations) may be configured to perform at least a portion of a function, or to duplicate performance of at least a portion of the function, and the term “base station” may refer to any one or more of those different devices. In some examples, “base station” may refer to one or more virtual base stations, one or more virtual base station functions, or a combination of thereof. For example, in some cases, two or more base station functions may be instantiated on a single device. In some examples, “base station” may refer to one of the base station functions and not another. In this way, a single device may include more than one base station.

For example, the wireless network 100 may include a control unit (CU) that communicates with a core network via a backhaul link. Furthermore, the CU may communicate with one or more distributed units (DUs) via respective midhaul links. The DUs may each communicate with one or more radio units (RUs) via respective fronthaul links, and the RUs may each communicate with respective UEs 120 via radio frequency (RF) access links. In some examples, the DUs and the RUs may be implemented according to a functional split architecture in which functionality of a base station 110 is provided by a DU and one or more RUs that communicate over a fronthaul link. Accordingly, as described herein, a base station 110 may include a DU and one or more RUs that may be co-located or geographically distributed. In some examples, the DU and the associated RU(s) may communicate via a fronthaul link to exchange real-time control plane information via a lower layer split (LLS) control plane (LLS-C) interface, to exchange non-real-time management information via an LLS management plane (LLS-M) interface, or to exchange user plane information via an LLS user plane (LLS-U) interface.

Accordingly, the DU may correspond to a logical unit that includes one or more base station functions to control the operation of one or more RUs. For example, in some examples, the DU may host a radio link control (RLC) layer, a medium access control (MAC) layer, and one or more high physical (PHY) layers (for example, forward error correction (FEC) encoding and decoding, scrambling, or modulation and demodulation) based at least in part on a lower layer functional split. Higher layer control functions, such as a packet data convergence protocol (PDCP), radio resource control (RRC), or service data adaptation protocol (SDAP), may be hosted by the CU 110. The RU(s) controlled by a DU may correspond to logical nodes that host RF processing functions and low-PHY layer functions (for example, fast Fourier transform (FFT), inverse FFT (iFFT), digital beamforming, or physical random access channel (PRACH) extraction and filtering) based at least in part on the lower layer functional split. Accordingly, in some examples, the RU(s) handle all over the air (OTA) communication with a UE 120, and real-time and non-real-time aspects of control and user plane communication with the RU(s) are controlled by the corresponding DU. This enables the DU(s) and the CU to be implemented in a cloud-based RAN architecture.

In some aspects, the UE 120 may include a communication manager 140. As described in more detail elsewhere herein, the communication manager 140 may receive a configuration for a CC configuring the CC for simultaneous transmissions associated with mTRPs; and transmit a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP. Additionally or alternatively, the communication manager 140 may perform one or more other operations described herein.

In some aspects, the base station 110 may include a communication manager 150. As described in more detail elsewhere herein, the communication manager 150 may transmit, to a UE, a configuration for a CC configuring the CC for simultaneous transmissions associated with mTRPs; and receive, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP. Additionally or alternatively, the communication manager 150 may perform one or more other operations described herein.

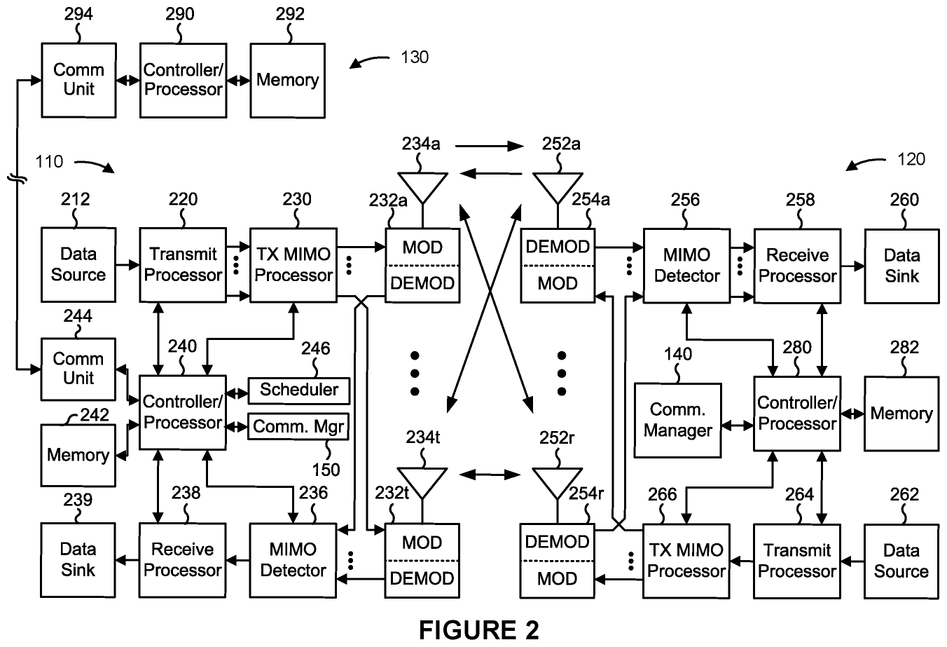

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a DMRS) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

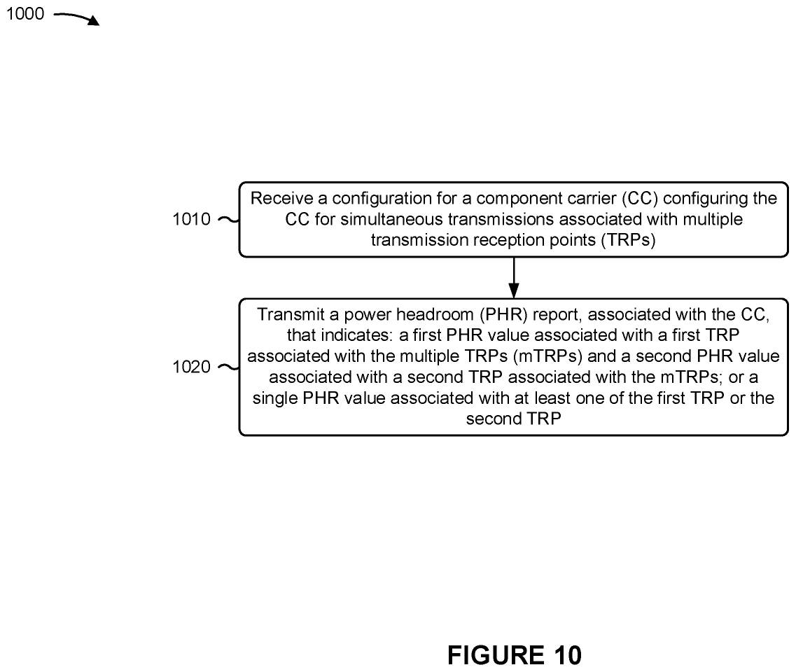

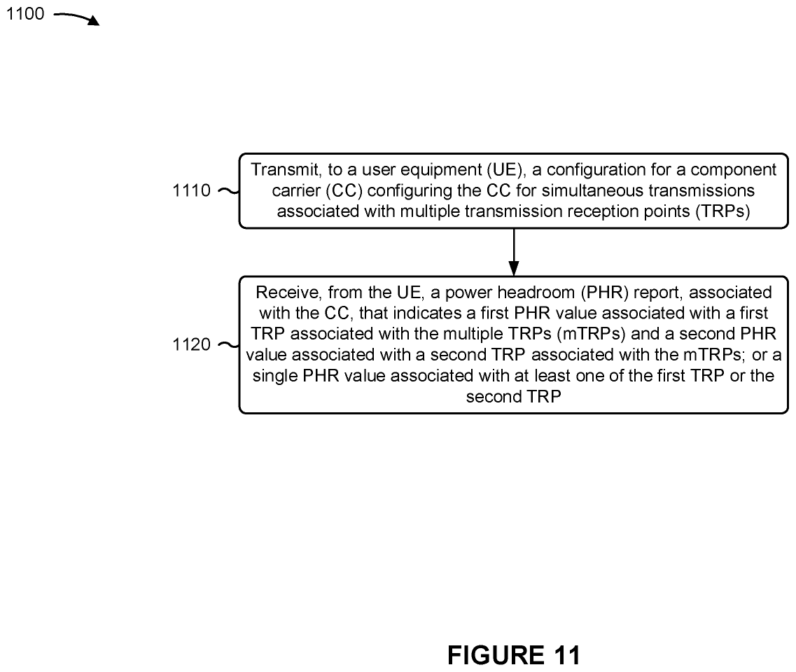

The controller/processor 240 of the base station 110, the controller/processor 280 of the UE 120, or any other component(s) of FIG. 2 may perform one or more techniques associated with a multiple PHR value reporting for mTRP scenarios with simultaneous transmissions, as described in more detail elsewhere herein. In some cases, power headroom may also be abbreviated as PH (for example, rather than PHR as used herein). For example, the controller/processor 240 of the base station 110, the controller/processor 280 of the UE 120, or any other component(s) of FIG. 2 may perform or direct operations of, for example, process 1000 of FIG. 10, process 1100 of FIG. 11, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 1000 of FIG. 10, process 1100 of FIG. 11, or other processes as described herein. In some examples, executing instructions may include running the instructions, converting the instructions, compiling the instructions, or interpreting the instructions, among other examples.

In some aspects, the UE 120 includes means for receiving a configuration for a CC configuring the CC for simultaneous transmissions associated with mTRPs; or means for transmitting a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, a configuration for a CC configuring the CC for simultaneous transmissions associated with mTRPs; or means for receiving, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

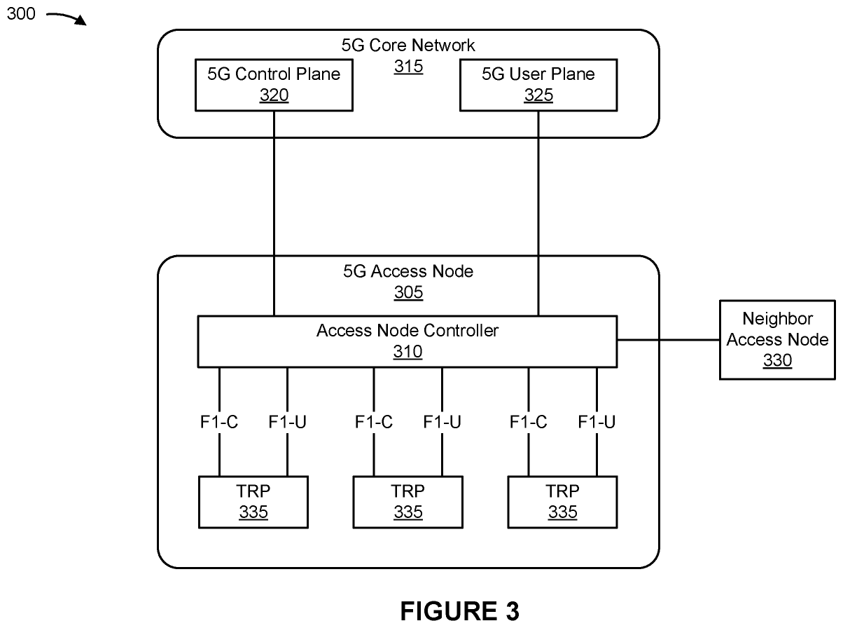

FIG. 3 illustrates an example logical architecture of a distributed radio access network (RAN) 300, in accordance with the present disclosure. A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (for example, a 5G gateway), and the backhaul interface for one or both of the 5G control plane and the 5G user plane may terminate at the access node controller 310. Additionally or alternatively, a backhaul interface to one or more neighbor access nodes 330 (for example, another 5G access node 305 or an LTE access node) may terminate at the access node controller 310.

The access node controller 310 may include or may communicate with one or more TRPs 335 (for example, via an F1 Control (F1-C) interface or an F1 User (F1-U) interface). A TRP 335 may be a distributed unit (DU) of the distributed RAN 300. In some examples, a TRP 335 may correspond to a base station 110 described above in connection with FIG. 1. For example, different TRPs 335 may be included in different base stations 110. Additionally or alternatively, multiple TRPs 335 may be included in a single base station 110. In some examples, a base station 110 may include a CU (for example, access node controller 310) or one or more DUs (for example, one or more TRPs 335). In some cases, a TRP 335 may be referred to as a cell, a panel, an antenna array, or an array.

A TRP 335 may be connected to a single access node controller 310 or to multiple access node controllers 310. In some examples, a dynamic configuration of split logical functions may be present within the architecture of distributed RAN 300. For example, a packet data convergence protocol (PDCP) layer, a radio link control (RLC) layer, or a MAC layer may be configured to terminate at the access node controller 310 or at a TRP 335.

In some examples, multiple TRPs 335 may transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). A TCI state indicates a spatial parameter for a communication. For example, a TCI state for a communication may identify a source signal (such as a synchronization signal block, or a channel state information reference signal, among other examples) and a spatial parameter to be derived from the source signal for the purpose of transmitting or receiving the communication. For example, the TCI state may indicate a quasi-colocation (QCL) type. A QCL type may indicate one or more spatial parameters to be derived from the source signal. The source signal may be referred to as a QCL source. In some examples, a TCI state may be used to indicate one or more QCL relationships. A TRP 335 may be configured to individually (for example, using dynamic selection) or jointly (for example, using joint transmission with one or more other TRPs 335) serve traffic to a UE 120.

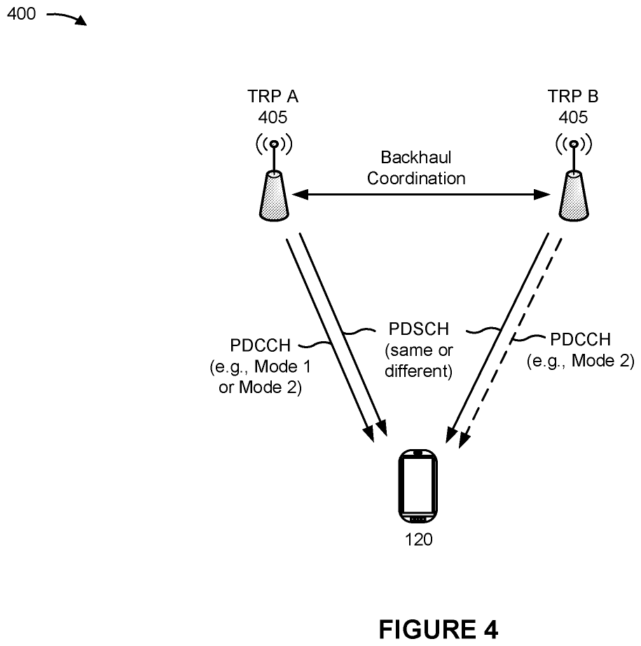

FIG. 4 is a diagram illustrating an example of multi-TRP (mTRP) communication 400, in accordance with the present disclosure. In some examples, multi-TRP communication may be referred to as multi-panel communication. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (for example, using coordinated multipoint transmissions) to improve reliability or increase throughput. The TRPs 405 may coordinate such communications via an interface between the TRPs 405 (for example, a backhaul interface or an access node controller 310). The interface may have a smaller delay or higher capacity when the TRPs 405 are co-located at the same base station 110 (for example, when the TRPs 405 are different antenna arrays or panels of the same base station 110), and may have a larger delay or lower capacity (as compared to co-location) when the TRPs 405 are located at different base stations 110. The different TRPs 405 may communicate with the UE 120 using different QCL relationships (for example, different TCI states), different DMRS ports, or different layers (for example, of a multi-layer communication).

In a first mTRP transmission mode (for example, Mode 1), a single physical downlink control channel (PDCCH) may be used to schedule data communications for a single physical downlink shared channel (PDSCH) or a single physical uplink shared channel (PUSCH). In such examples, multiple TRPs 405 (for example, TRP A and TRP B) may transmit communications to the UE 120 on the same PDSCH. For example, a communication may be transmitted using a single codeword with different spatial layers for different TRPs 405 (for example, where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (for example, using different sets of layers), and different codewords may correspond to different redundancy versions of one transport block. In either case, different TRPs 405 may use different QCL relationships (for example, different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some examples, a TCI state indicator in DCI (for example, transmitted on the PDCCH, such as DCI format 1_0 or DCI format 1_1) may indicate the first QCL relationship (for example, by indicating a first TCI state) and the second QCL relationship (for example, by indicating a second TCI state). The first and the second TCI states may be indicated using a TCI field in the DCI. In general, the TCI field can indicate a single TCI state (for single TRP transmission) or multiple TCI states (for multi-TRP transmission as discussed here) in this mTRP transmission mode (for example, Mode 1).

In a second mTRP transmission mode (for example, Mode 2), multiple PDCCHs may be used to schedule data communications for multiple corresponding PDSCHs or PUSCHs (for example, one PDCCH for each PDSCH or each PUSCH). In such examples, a first PDCCH may schedule a first codeword to be transmitted by a first TRP 405, and a second PDCCH may schedule a second codeword to be transmitted by a second TRP 405. Furthermore, first DCI (for example, transmitted by the first TRP 405) may schedule a first PDSCH or a first PUSCH communication associated with a first set of DMRS ports with a first QCL relationship (for example, indicated by a first TCI state) for the first TRP 405, and second DCI (for example, transmitted by the second TRP 405) may schedule a second PDSCH or a first PUSCH communication associated with a second set of DMRS ports with a second QCL relationship (for example, indicated by a second TCI state) for the second TRP 405. In such examples, DCI (for example, having DCI format 1_0 or DCI format 1_1) may indicate a corresponding TCI state for a TRP 405 corresponding to the DCI. The TCI field of a DCI indicates the corresponding TCI state (for example, the TCI field of the first DCI indicates the first TCI state, and the TCI field of the second DCI indicates the second TCI state).

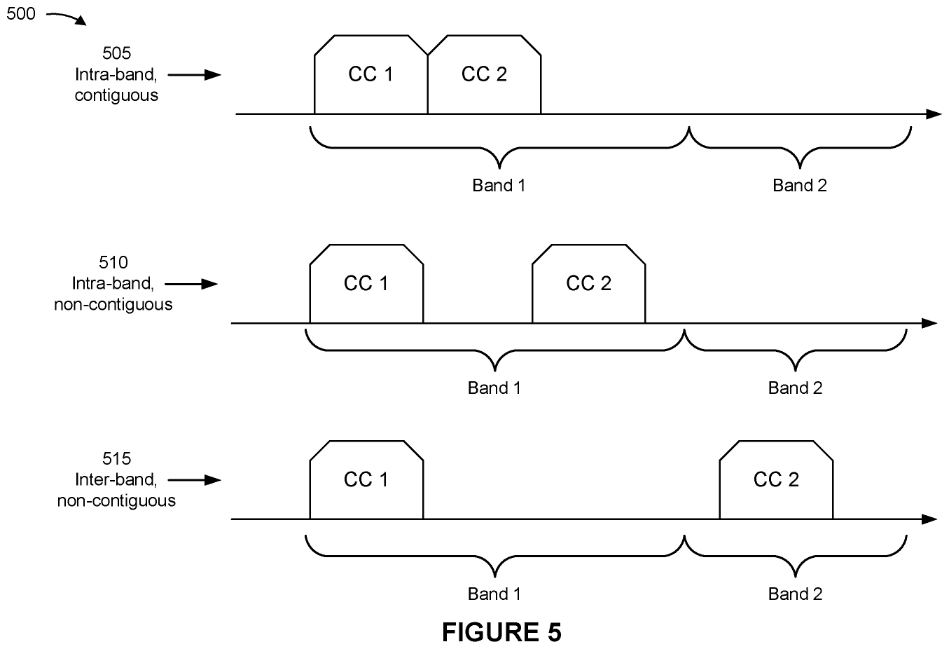

FIG. 5 is a diagram illustrating examples of carrier aggregation 500, in accordance with the present disclosure. Carrier aggregation is a technology that enables two or more CCs, sometimes referred to as carriers, to be combined (for example, into a single channel) for a single UE 120 to enhance data capacity. As shown, carriers can be combined in the same or different frequency bands. Additionally or alternatively, contiguous or non-contiguous carriers can be combined. A base station 110 may configure carrier aggregation for a UE 120, such as in a radio resource control (RRC) message, DCI, or another signaling message.

In some examples, carrier aggregation may be configured in an intra-band contiguous mode 505 where the aggregated carriers are contiguous to one another and are in the same band. In some examples, carrier aggregation may be configured in an intra-band non-contiguous mode 510 where the aggregated carriers are non-contiguous to one another and are in the same band. In some examples, carrier aggregation may be configured in an inter-band non-contiguous mode 515 where the aggregated carriers are non-contiguous to one another and are in different bands.

In carrier aggregation, a UE 120 may be configured with a primary carrier or primary cell (PCell) and one or more secondary carriers or secondary cells (SCells). In some examples, the primary carrier may carry control information (for example, downlink control information or scheduling information) for scheduling data communications on one or more secondary carriers, which may be referred to as cross-carrier scheduling. In some examples, a carrier (for example, a primary carrier or a secondary carrier) may carry control information for scheduling data communications on the carrier, which may be referred to as self-carrier scheduling or carrier self-scheduling.

In some examples, a CC may be configured for mTRP operations. For example, a base station or a TRP may configure a CC to be associated with multi-TRP operations. In such examples, a UE may use the CC to communicate mTRP communications, such as in a similar manner as described in connection with FIG. 4.

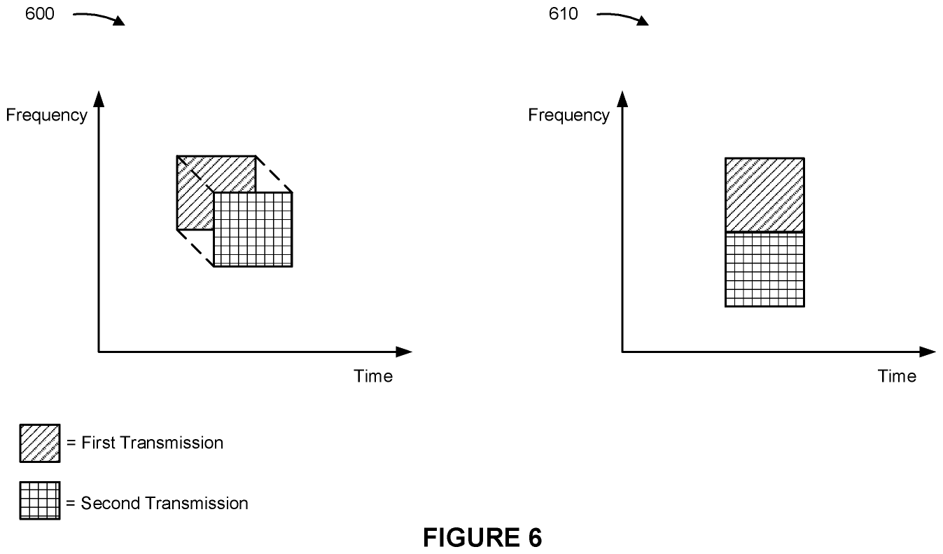

FIG. 6 is a diagram illustrating examples of simultaneous transmissions, in accordance with the present disclosure. As used herein, “simultaneous transmissions” may refer to two or more transmissions that at least partially overlap in the time domain. For example, simultaneous transmissions may share one or more common time domain resources (such as one or more common OFDM symbols). In some examples, simultaneous transmissions may share a common starting time domain resource (for example, may share a common starting OFDM symbol). In other words, a transmission of the simultaneous transmissions may begin at the same time. In some examples, simultaneous transmissions may occupy the same time domain resources (for example, as depicted in FIG. 6).

As shown in FIG. 6, the simultaneous transmissions may include a first transmission and a second transmission that are both transmitted by the same device, such as by a UE. In such examples, the first transmission and the second transmission may be uplink transmissions, such as PUSCH transmissions. In some examples, the first transmission may be associated with a first antenna panel or first antenna element(s) of the UE and the second transmission may be associated with a second antenna panel or second antenna element(s) of the UE. Additionally or alternatively, the first transmission may be associated with a first transmitted precoding matrix indicator (TPMI) and the second transmission may be associated with a second TPMI. Additionally or alternatively, the first transmission may be associated with a first SRS resource indication (SRI) and the second transmission may be associated with a second SRI (for example, the first transmission may be associated with a first SRS resource or a first SRS resource set and the second transmission may be associated with a second SRS resource or a second SRS resource set). Additionally or alternatively, the first transmission may be associated with a first uplink TCI state and the second transmission may be associated with a second TCI state (for example, the first transmission may be associated with a first uplink beam or a first uplink spatial transmit direction and the second transmission may be associated with a second uplink beam or a second uplink spatial transmit direction).

For example, the first transmission and the second transmission may be scheduled via DCI that indicates the antenna panels, TPMIs, the SRIs, or the uplink TCI states associated with the first transmission and the second transmission. In some examples, a single DCI message may schedule both the first transmission and the second transmission (for example, single DCI-based scheduling). In some other examples, the first transmission may be scheduled by a first DCI message and the second transmission may be scheduled by a second DCI message (for example, multiple DCI-based scheduling). In some examples, the first transmission and the second transmission may be associated with a mTRP scenario (for example, in a similar manner as described elsewhere herein). For example, the first transmission may be associated with a first TRP and the second transmission may be associated with a second TRP (for example, the first transmission may be to the first TRP and the second transmission may be to the second TRP). For example, the simultaneous transmission may be associated with single DCI-based scheduling or multiple DCI-based scheduling for mTRP PUSCH transmissions.

As a first example, the simultaneous transmissions may be spatial division multiplex (SDM) transmissions 600. “Spatial division multiplexing” refers to performing two or more transmissions using different spatial parameters, such as different TCI states corresponding to beams, or using different antenna panels, among other examples. As shown in FIG. 6, SDM transmissions 600 can use overlapped time resources and frequency resources (for example, the first transmission and the second transmission may use the same time domain resources and the same frequency domain resources). As a second example, the simultaneous transmission may be frequency division multiplex (FDM) transmissions 610. “Frequency division multiplexing” refers to performing two or more transmissions using overlapped time resources and different frequency domain resources. For example, as shown in FIG. 6, the first transmission and the second transmission may use the same time domain resources and different frequency domain resources. In some examples, the FDM transmissions 605 may use overlapped spatial resources (that is, overlapped beam parameters, TCI states, or spatial transmission directions, among other examples).

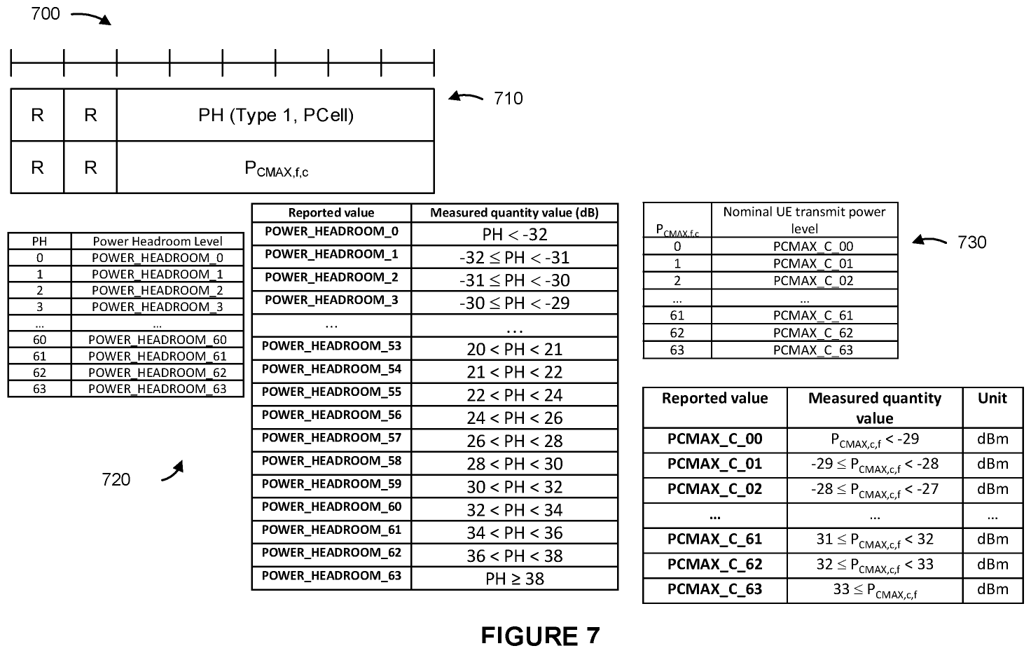

FIG. 7 is a diagram illustrating an example of power headroom reporting 700, in accordance with the present disclosure. As shown in FIG. 7, a PHR report 710 may be transmitted from a UE to a base station. The PHR report 710 is a UE generated report to the base station that provides the base station with an indication of how much power the UE has or is using.

The PHR may indicate an amount of remaining transmission power available to a UE in addition to power being used by a current transmission. The PHR may be based at least in part on a difference between a UE maximum transmission power and a PUSCH transmission power. A PHR report may be a Type 1 report for a PUSCH, a Type 3 report for an SRS, or a Type 2 report for a physical uplink control channel (PUCCH). For example, types of UE PHRs may include a Type 1 UE power headroom that is valid for a PUSCH transmission occasion i on an active uplink bandwidth part (BWP) b of carrier f of serving cell c, or a Type 3 UE power headroom that is valid for an SRS transmission occasion i on an active uplink BWP b of carrier f of serving cell c. Thus, a PHR report may be determined for a component carrier or serving cell.

A UE may determine whether a PHR for an activated serving cell is based at least in part on an actual transmission. The actual transmission may be determined based at least in part on higher layer signalling of configured grant and periodic/semi-persistent SRS transmissions, or DCI signalling received by the UE. The UE may determine whether the PHR report for the activated serving cell is based at least in part on an uplink transmission format. The uplink transmission format may be determined based at least in part on default parameters, or parameters indicated by DCI signalling received at the UE. The parameters may include the resource allocation parameters, transmit power control parameters, or modulation parameters, among other examples. A PHR report for an activated serving cell may be referred to as a virtual PHR or may be provided via a virtual PHR. “Virtual PHR” may refer to a PHR that is estimated by the UE using one or more default power control parameters and is based on a default uplink transmission. For example, a virtual PHR may not be associated with an actual transmission by the UE (for example, a virtual PHR may not be associated with a DCI scheduled PUSCH occasion). Rather, the UE may use the one or more default power control parameters to estimate the virtual PHR (for example, rather than using power control parameters associated with an actual transmission). As used herein “PUSCH occasion” may refer to one or more time-frequency resources that are associated with a PUSCH communication. For example, DCI may indicate, or allocate, the one or more time-frequency resources when scheduling the PUSCH communication.

When a UE determines that a Type 1 PHR for an activated serving cell is based at least in part on an actual PUSCH transmission, for a PUSCH transmission occasion i on an active uplink BWP b of carrier f of serving cell c, the UE may compute the Type 1 PHR as:

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \}$$

With respect to the Type 1 PHR (in decibels (dB)) based at least in part on an actual PUSCH transmission, P_{CMAX,}_{_{f,c}} (i) may represent a UE configured maximum output power after backoff due to power management (for example, backoff due to a maximum power reduction), and P_{O_PUSCH,b,fb,f,c,c}(j), M_{RB,b,f,c}^{PUSCH}(i), α_{b,f,c} (j), PL_{b,f,c} (q_{d}), Δ_{TF,b,f,c}(i) and f_{b,f,c}(i,l) may be parameters used to determine a PUSCH transmit power.

When the UE determines that a Type 1 PHR for an activated serving cell is based at least in part on a reference PUSCH transmission, for a PUSCH transmission occasion i on an active uplink BWP b of carrier f of serving cell c, the UE may compute the Type 1 PHR as:

$${PH}_{type 1 , b , f , c} ( i , j , {q}_{d} , l ) = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} [ dB ]$$

With respect to the Type 1 PHR (in dB) based at least in part on a reference PUSCH transmission (for example, a virtual power headroom report), \tilde{P}_{CMAX,}_{_{f,c}} (i) may be computed assuming no backoff (for example, maximum power reduction (MPR) values may be assumed to be 0 dB), and P_{O_PUSCH,b,f,c}(j), α_{b,f,c} (j), PL_{b,f,c} (q_{d}), and f_{b,f,c} (i,l) may be based at least in part on default or reference parameters of j, i, l, and q_{d}, where for P0 and alpha, p0-PUSCH-AlphaSetId is equal to 0, and for path loss, pusch-PathlossReferenceRS-Id is equal to 0, and for closedloopindex, l is equal to 0.

A PHR report may be triggered by a MAC layer, and the PHR report may be triggered based at least in part on an occurrence of one or more triggering events. For example, the PHR report may be triggered by a set of timers, such as a phr-PeriodicTimer or a phr-ProhibitTimer. The PHR report may be triggered by a power change that satisfies a configurable threshold for a pathloss reference signal used for power control in an uplink component carrier. The PHR report may be triggered by an activation of an SCell. The PHR report may be triggered when an active BWP of a configured component carrier is changed from a dormant state to a non-dormant state.

A triggered PHR report may be transmitted in a PHR report MAC-CE on a first available PUSCH corresponding to an initial transmission of a transport block that can accommodate the PHR MAC-CE as a result of logical channel prioritization. The PUSCH may be dynamic (for example, scheduled by DCI), or the PUSCH can be a configured-grant PUSCH.

A UE may be configured with multiple component carriers for a PUSCH transmission. The PHR MAC-CE may include a PHR report for more than one component carrier when a multiplePHR parameter is enabled via RRC signaling. Otherwise, the PHR report may be a report for a PCell and a single-entry PHR MAC-CE format may be used. When a first PUSCH in a first component carrier carries the PHR MAC-CE, for a second component carrier, the PHR MAC-CE may include an actual PHR or a virtual PHR (based on a reference format). When a PUSCH transmission is performed on the second component carrier at a time of power headroom reporting (for example, in a slot of the first PUSCH), and the PUSCH transmission on the second component carrier is scheduled by DCI that satisfies a timeline condition, the PHR MAC-CE may include the actual PHR. Otherwise, the MAC-CE may include the virtual PHR.

In some examples, the UE may determine a PUSCH occasion to be used to calculate a PHR when the UE is configured with multiple component carriers. The UE may determine the PUSCH occasion based at least in part on information defined, or otherwise fixed, by a wireless communication standard, such as the 3GPP (for example, such as in 3GPP Technical Specification 38.213, Version 16.2.0, Section 7.7). The UE may determine the PUSCH occasion based at least in part on an earliest time occasion of a PUSCH occasion on the component carrier. For example, if a UE is configured with multiple cells for PUSCH transmissions, where a subcarrier spacing (SCS) configuration μ₁ on active uplink BWP b₁ of carrier f₁ of serving cell c₁ is smaller than an SCS configuration μ₂ on active uplink BWP b₂ of carrier f₂ of serving cell c₂, and if the UE provides a Type 1 power headroom report in a PUSCH transmission in a slot on active uplink BWP b₁ that overlaps with multiple slots on active uplink BWP b₂, then the UE provides a Type 1 power headroom report for the first PUSCH, if any, on the first slot of the multiple slots on active uplink BWP b₂ that fully overlaps with the slot on active uplink BWP b₁. If a UE is configured with multiple cells for PUSCH transmissions, where a same SCS configuration on active uplink BWP b₁ of carrier f₁ of serving cell c₁ and active uplink BWP b₂ of carrier f₂ of serving cell c₂, and if the UE provides a Type 1 power headroom report in a PUSCH transmission in a slot on active uplink BWP b, then the UE provides a Type 1 power headroom report for the first PUSCH, if any, on the slot on active uplink BWP b₂ that overlaps with the slot on active uplink BWP b₁.

The PHR MAC-CE may be a single-entry PHR MAC-CE, as shown in FIG. 7, or a multiple-entry PHR MAC-CE. The single-entry PHR MAC-CE may include a PHR field, which may indicate a PHR level for the PCell, and a P_{CMAX,f,c} field, which may indicate the P_{CMAX,f,c} used for calculating the preceding PHR field. The multiple-entry PHR MAC-CE may include entries for the PCell and a plurality of SCells. For example, for the PCell or a given SCell, the multiple-entry PHR MAC-CE may include the corresponding PHR field, the P_{CMAX,f,c} field, a “V” value which may indicate whether a PHR value in the PHR field corresponds to a real transmission or a reference format, and a “P” value which may indicate whether power backoff is applied due to power management.

As shown in FIG. 7, the PHR value 710 of the PHR report may occupy a set of 6 bits, which provides a range from 0 to 63. The 64 PHR values of the PHR report are mapped to actual PHR values (for example, in dB) using PHR lookup tables 720. As further shown in FIG. 7, the P_{CMAX,f,c} value, which was used to calculate the PHR value, also occupies a set of 6 bits and also provides a range from 0 to 63. The 64 P_{CMAX,f,c} values are mapped to actual P_{CMAX,f,c} values (for example, in dB-milliwatts (dBm)) using P_{CMAX,f,c} lookup tables 730. The ‘R’ fields of the PHR may be reserved or populated with 0s (zeros).

In some examples, a UE may support PHR reporting in mTRP scenarios. In some cases, for PHR reporting related to mTRP PUSCH repetitions, a UE may report two PHR values. The PHR values may be associated with a first PUSCH occasion for each TRP (for example, each TRP associated with the mTRP scenario) in a slot for a component carrier (for example, a component carrier that is configured for the mTRP communications). For example, the UE may calculate two PHRs (at least corresponding to the CC that applies mTRP PUSCH repetitions), each associated with a first PUSCH occasion to each TRP, and the UE may report two PHRs. In other words, the UE may report two power headroom reports, corresponding to two TRPs, in a single PHR MAC-CE for mTRP PUSCH repetitions.

In some examples, when a PHR report is transmitted in a slot n, if a first PHR value associated with a first TRP is an actual PHR corresponding to a repetition among mTRP PUSCH repetition associated with the first TRP, then the second PHR value may be an actual PHR value if a repetition associated with a second TRP is transmitted in slot n. If there are multiple repetitions associated with the second TRP in the slot n, then the repetition that occurs earliest in the time domain in slot n may be selected by the UE to calculate the second PHR value. If no repetitions associated with the second TRP occur in the slot n, then the second PHR value may be a virtual PHR value. If the first PHR value associated with the PHR report is an actual PHR value, but does not correspond to a repetition among mTRP PUSCH repetitions (for example, if the first PHR value corresponds to a single TRP PUSCH transmission associated with the first TRP), then the second PHR value may be a virtual PHR value associated with the second TRP. If the first PHR value associated with the PHR report is a virtual PHR value associated with the first TRP, then the second PHR value may be a virtual PHR value associated with the second TRP. As described elsewhere herein, a virtual PHR value may be calculated by a UE using a set of default power control parameters defined or configured for a given TRP. For example, a virtual PHR value associated with the first TRP may be calculated by the UE using a first set of default power control parameters defined or configured for the first TRP. Similarly, a virtual PHR value associated with the second TRP may be calculated by the UE using a second set of default power control parameters defined or configured for the second TRP. If the UE does not support transmitting multiple PHRs corresponding to different TRPs in the same PHR report, then the UE report a PHR value corresponding to a PUSCH occasion that occurs first in a slot in which the PHR report is transmitted or may transmit a virtual PHR in a similar manner as described above.

However, in some cases, mTRP scenarios may be associated with simultaneous transmissions. For example, in some cases, the simultaneous transmissions may begin at the same time (such as at the same OFDM symbol). However, signaling and coordination for PHR reports associated with mTRP simultaneous transmissions is not defined (for example, by a wireless communication standard). For example, in cases where the simultaneous transmissions begin at the same, or approximately the same, there may be a lack of coordination between a UE and TRPs (or base station) as to which transmission is to be considered a “first” transmission for purposes of calculating and reporting PHR values for multiple TRPs. Additionally, some UEs may not support transmitting PHR reports that include multiple PHR values that correspond to different TRPs. In such examples, coordination as to which transmission, among the simultaneous transmissions, is to be used to calculate a PHR to be reported by the UE may not be defined. As a result, a TRP (or base station) may incorrectly interpret a PHR report transmitted by the UE. For example, a TRP may incorrectly interpret a PHR value included in the PHR report as being associated with the TRP when the PHR value is actually associated with another TRP in an mTRP scenario (for example, because of the lack of coordination between the UE and the TRPs).

Various aspects relate generally to PHR reports for mTRP scenarios with simultaneous transmissions. Some aspects more specifically relate to PHR reports including multiple PHR values corresponding to different TRPs for mTRP scenarios with simultaneous transmissions. In some aspects, a UE may receive a configuration for a CC configuring the CC for simultaneous transmissions associated with mTRP operations. The UE may transmit a PHR report associated with the CC. In some aspects, the PHR report may indicate a first PHR value associated with a first TRP associated with the mTRP operations and a second PHR value associated with a second TRP of the mTRP operations. For example, the PHR report may include multiple PHR values corresponding to respective TRPs of the mTRP operations. In some aspects, the PHR report may indicate the first PHR value and the second PHR value based at least in part on the UE being capable of transmitting PHR reports that indicate multiple PHR values.

In some other aspects, the PHR report may indicate a single PHR value associated with the mTRP operations. For example, the PHR report may indicate the single PHR value based at least in part on the UE not being capable of transmitting PHR reports that indicate multiple PHR values. In some aspects, the UE may identify a physical uplink shared channel (PUSCH) occasion (for example, from multiple PUSCH occasions associated with the simultaneous transmissions) to be used to calculate the single PHR value (or a first PUSCH occasion, to be associated with a first PHR value, when the PHR report indicates the first PHR value and a second PHR value) based at least in part on one or more rules. In some aspects, the one or more rules may be based at least in part on sounding reference signal (SRS) resource set identifiers associated with the multiple PUSCH occasions, transmission configuration indicator (TCI) state identifiers associated with the multiple PUSCH occasions, closed loop index values associated with the multiple PUSCH occasions, an order of the multiple PUSCH occasions as indicated by dynamic switching indicator or TCI states included in a downlink control information (DCI) message that schedules the multiple PUSCH occasions, frequency domain resource allocations associated with the multiple PUSCH occasions, demodulation reference signal (DMRS) code division multiplex (CDM) group identifiers associated with the multiple PUSCH occasions, or control resource set (CORESET) pool index values associated with the multiple PUSCH occasions, among other examples.

Particular aspects of the subject matter described in this disclosure can be implemented to realize one or more of the following potential advantages. In some examples, the described techniques can be used to enable a UE to transmit a PHR report that includes multiple PHR values when a CC is configured to enable simultaneous transmissions associated with mTRP operations. In some aspects, the described techniques can be used to enable coordination between a UE and TRPs (or base stations) for PHR reporting when a CC is configured to enable simultaneous transmissions associated with mTRP operations. As a result, a TRP (or a base station) may be enabled to correctly interpret the PHR report and associate a PHR value included in the PHR report with the correct TRP or PUSCH occasion.

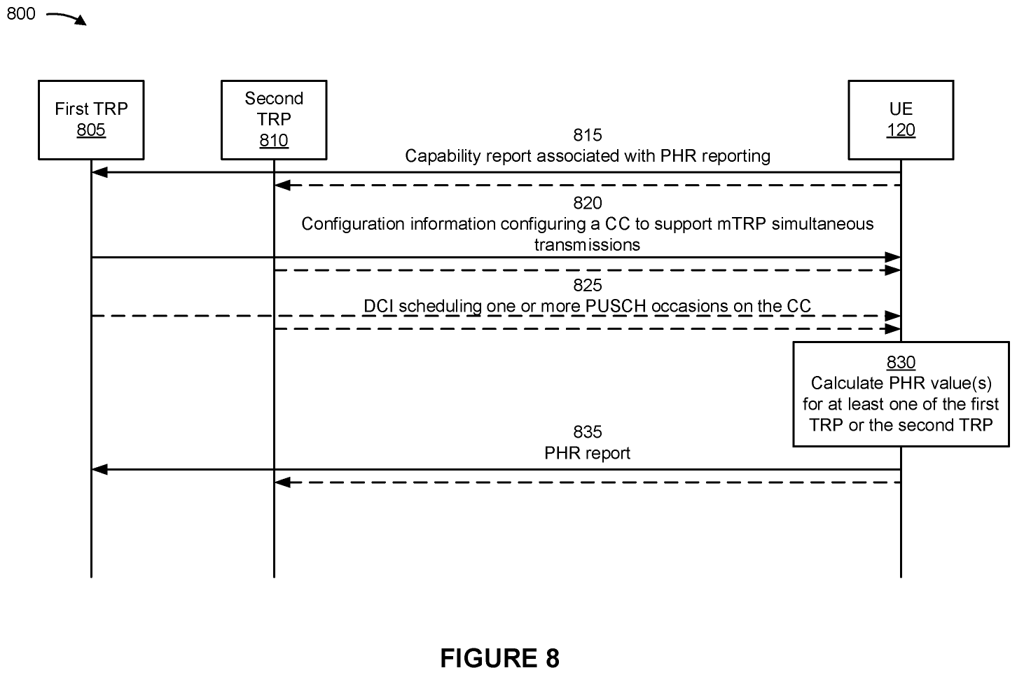

FIG. 8 is a diagram of an example associated with a multiple PHR value reporting 800 for mTRP scenarios with simultaneous transmissions, in accordance with the present disclosure. As shown in FIG. 8, a UE 120 may communicate with a first TRP 805 and a second TRP 810 (for example, in an mTRP configuration). In some aspects, the first TRP 805 and the second TRP 810 may be associated with a base station 110 (for example, the same base station or different base stations). In some aspects, the first TRP 805, the second TRP 810, and the UE may be part of a wireless network (for example, the wireless network 100). The UE may have established a wireless connection with the first TRP 805 and the second TRP 810 prior to operations shown in FIG. 8.

In a first operation 815, the UE 120 may transmit a capability report. In some aspects, the UE 120 may transmit the capability report to the first TRP 805 or the second TRP 810. In some other aspects, the UE 120 may transmit the capability report to another network entity (for example, a base station or another network entity that manages or controls the first TRP 805 and the second TRP 810). The capability report may indicate one or more capabilities of the UE 120. For example, the capability report may indicate one or more operations or functions supported by the UE 120. The UE 120 may transmit the capability report via a PUCCH message, a UE assistance information (UAI) message, a UE capability report message, an uplink control information message, an RRC message, or another type of message.

In some aspects, the capability report may indicate whether the UE 120 is capable of transmitting PHR reports that include multiple PHR values associated with multiple TRPs associated with the mTRP operations in simultaneous transmission scenarios. For example, in some cases, the UE 120 may be capable of transmitting PHR reports that include multiple PHR indications associated with multiple TRPs (for example, in mTRP simultaneous transmission scenarios). For example, the UE 120 may be capable of reporting PHR values for each TRP associated with an mTRP operation in simultaneous transmission scenarios. In some other cases, the UE 120 may not be capable of transmitting PHR reports that include multiple PHR indications associated with multiple TRPs (for example, in mTRP simultaneous transmission scenarios). For example, the UE 120 may not be capable of report PHR values for each TRP associated with an mTRP operation in simultaneous transmission scenarios. The capability report may include an indication of the UE capability associated with PHR reporting in mTRP scenarios with simultaneous transmissions.

In a second operation 820, the first TRP 805 or the second TRP 810 may transmit, and the UE 120 may receive, configuration information. In some other aspects, another network entity, such as a base station 110, may transmit the configuration information to the UE 120 in the second operation 820. In some aspects, the UE 120 may receive the configuration information via one or more of RRC signaling, one or more MAC-CEs, or DCI, among other examples. In some aspects, the configuration information may include an indication of one or more configuration parameters (for example, already known to the UE 120 or previously indicated by one of the TRPs or another network entity) for selection by the UE 120, or explicit configuration information for the UE 120 to use to configure the UE 120, among other examples.

In some aspects, the configuration information may be an mTRP configuration. For example, the configuration information may configure the first TRP 805 and the second TRP 810 to communicate with the UE 120 in a coordinated manner (for example, using coordinated multipoint transmissions) to improve reliability or increase throughput. For example, the configuration information may configure the first TRP 805 and the second TRP 810 to communicate with the UE 120 in a similar manner as described in connection with FIG. 4.

In some aspects, the configuration information may configure one or more CCs associated with the UE 120. For example, the configuration information may configure the UE 120 to communicate using the one or more CCs. In some aspects, the configuration information may configure one or more CCs to be associated with mTRP communications. For example, the configuration information may configure the first TRP 805 and the second TRP 810 to communicate with the UE 120 via a CC. In some aspects, the configuration information may configure a CC for simultaneous transmissions. For example, the UE 120 may receive a configuration for a CC configuring the CC for simultaneous transmissions associated with mTRP operations. In other words, the configuration information may indicate that simultaneous transmissions associated with mTRP operations (for example, associated with the first TRP 805 and the second TRP 810) may be transmitted via the CC.

In some aspects, the configuration information may indicate that the UE 120 is to transmit PHR reports associated with the CC that is configured for simultaneous transmissions associated with mTRP operations. In some aspects, the configuration information may indicate that the PHR reports, associated with the CC that is configured for simultaneous transmissions associated with mTRP operations, are to include PHR values for each TRP associated with the mTRP operations (for example, a first PHR value associated with the first TRP 805 and a second PHR value associated with the second TRP 810). In some other aspects, the configuration information may indicate that the PHR reports, associated with the CC that is configured for simultaneous transmissions associated with mTRP operations, are to include a single PHR value or only PHR values associated with a single TRP. In some aspects, the configuration information may indicate one or more rules to be used by the UE 120 to identify a PUSCH occasion that is to be used to calculate a PHR value in simultaneous transmission scenarios associated with mTRP operations. The one or more rules are described in more detail elsewhere herein.

In some aspects, the configuration information may be based at least in part on the capability report transmitted by the UE 120 in the first operation 815. For example, the first TRP 805, the second TRP 810, or a base station (for example, the entity that transmits the configuration information in the second operation 820) may determine the configuration information based at least in part on the one or more capabilities reported by the UE 120. For example, if the UE 120 reports that the UE 120 is capable of reporting PHR values for each TRP associated with an mTRP operation in simultaneous transmission scenarios, then the configuration information may indicate that the PHR reports, associated with the CC that is configured for simultaneous transmissions associated with mTRP operations, are to include PHR values for each TRP associated with the mTRP operations (for example, a first PHR value associated with the first TRP 805 and a second PHR value associated with the second TRP 810). Alternatively, if the UE 120 reports that the UE 120 is not capable of reporting PHR values for each TRP associated with an mTRP operation in simultaneous transmission scenarios, then the configuration information may indicate that the PHR reports, associated with the CC that is configured for simultaneous transmissions associated with mTRP operations, are to include a single PHR value or only PHR value(s) associated with a single TRP.

The UE 120 may configure itself based at least in part on the configuration information. In some aspects, the UE 120 may be configured to perform one or more operations described herein based at least in part on the configuration information.

In some aspects, in a third operation 825, the first TRP 805, the second TRP 810, or a base station may transmit, and the UE 120 may receive, DCI scheduling one or more PUSCH occasions on the CC (for example, the CC that is configured for simultaneous transmissions associated with mTRP operations). For example, the PUSCH occasions may be scheduled via single DCI-based scheduling or multiple DCI-based scheduling. In single DCI-based scheduling, a single DCI message may schedule PUSCH occasions for the mTRP operations (for example, for PUSCH communications associated with the first TRP 805 and the second TRP 810). In multiple DCI-based scheduling, multiple DCI messages may schedule PUSCH occasions for the mTRP operations (for example, a first DCI message may schedule PUSCH communications associated with the first TRP 805 and a second DCI message may schedule PUSCH communications associated with the second TRP 810). In some aspects, the DCI may schedule simultaneous transmissions (for example, simultaneous uplink transmissions) to the first TRP 805 and the second TRP 810. The simultaneous transmissions may be SDM transmissions or FDM transmissions. In some other aspects, the DCI may schedule an uplink transmission associated with a single TRP (for example, to either the first TRP 805 or the second TRP 810). In some other aspects, the UE 120 may not receive DCI scheduling uplink transmissions to the first TRP 805 or the second TRP 810.

In a fourth operation 830, the UE 120 may calculate one or more PHR values for at least one of the first TRP 805 or the second TRP 810 (for example, to be included in a PHR report). For example, the UE 120 may calculate one or more PHR values associated with the CC that is configured for simultaneous transmissions associated with mTRP operations. The UE 120 may calculate and report the one or more PHR values in accordance with the configuration information. In some aspects, the UE 120 may calculate the one or more PHR values in the fourth operation 830 based at least in part on being triggered to transmit a PHR report. A PHR report may be triggered by a MAC layer, and the PHR report may be triggered based at least in part on an occurrence of one or more triggering events. For example, the PHR report may be triggered by a set of timers, such as a phr-PeriodicTimer or a phr-ProhibitTimer. The PHR report may be triggered by a power change that satisfies a configurable threshold for a pathloss reference signal used for power control in the CC (for example, the CC that is configured for simultaneous transmissions associated with mTRP operations). The PHR report may be triggered by an activation of an SCell (for example, associated with the CC that is configured for simultaneous transmissions associated with mTRP operations). The PHR report may be triggered when an active BWP of the CC (for example, the CC that is configured for simultaneous transmissions associated with mTRP operations) is changed from a dormant state to a non-dormant state. The PHR report may be triggered based at least in part one or more other trigger events (for example, as defined, or otherwise fixed, by a wireless communication standard, such as the 3GPP).

In some aspects, the UE 120 may determine that the PHR report is to be transmitted in a given slot (for example, based at least in part on a timing of a triggering event that triggers the transmission of the PHR report). In some aspects, the UE 120 may calculate multiple per-TRP PHR values, each associated with a PUSCH occasion for a TRP. In other words, the UE 120 may calculate one or more PHR values for each TRP associated with the mTRP operations. As described in more detail elsewhere herein, the PHR values may be actual PHR values (for example, associated with a scheduled PUSCH occasion) or virtual PHR values (for example, calculated using default power control parameters associated with a given TRP).

For example, the UE 120 may calculate a first PHR value associated with the CC that is configured for simultaneous transmissions associated with mTRP operations. In some aspects, the first PHR value may be a virtual PHR value. In such examples, the UE 120 may calculate the first PHR value in a similar manner as described elsewhere herein (for example, such as in connection with FIG. 7). In some aspects, the first PHR value may be an actual PHR value. In such examples, the UE 120 may identify a first PUSCH occasion (for example, in the time domain) that overlaps with the slot in which the PHR report is to be transmitted. The UE 120 may calculate the first PHR value using one or more power control parameters associated with the first PUSCH occasion.

In some cases, there may be multiple PUSCH occasions that are associated with the same starting symbol in the slot in which the PHR report is to be transmitted. For example, the UE 120 may be scheduled with simultaneous transmissions that are to be transmitted at the same starting time. In such examples, the PUSCH occasion, from the multiple PUSCH occasions, that is to be associated with the first PHR value may be based at least in part on one or more rules. For example, the UE 120 may identify the PUSCH occasion, from the multiple PUSCH occasions, that is to be associated with the first PHR value based at least in part on the one or more rules. The one or more rules may be configured (for example, via the configuration information in the second operation 820) or may be defined (for example, by a wireless communication standard, such as the 3GPP). In examples where the one or more rules are defined, the one or more rules may be pre-configured or stored on the UE 120 (for example, and not transmitted to the UE 120).

In some aspects, the one or more rules may be based at least in part on SRS resource set identifiers associated with the multiple PUSCH occasions, TCI state identifiers associated with the multiple PUSCH occasions, closed loop index values associated with the multiple PUSCH occasions, an order of the multiple PUSCH occasions as indicated by dynamic switching indicator or TCI states included in a DCI message that schedules the multiple PUSCH occasions, frequency domain resource allocations associated with the multiple PUSCH occasions, DMRS CDM group identifiers associated with the multiple PUSCH occasions, or CORESET pool index values associated with the multiple PUSCH occasions, among other examples. For example, in accordance with the one or more rules, the PUSCH occasion may be based at least in part on SRS resource set identifiers (or SRS resource identifiers, such as when the multiple PUSCH occasions are associated with the same SRS resource set) associated with the multiple PUSCH occasions. For example, each of the multiple PUSCH occasions may be associated with an SRS resource set. The SRS resource sets may be associated with a codebook usage type or a non-codebook usage type, among other examples. The SRS resource sets may be associated with MIMO communications. For example, DCI scheduling the multiple PUSCH occasions may indicate an SRS resource set identifier associated with a given PUSCH occasion. The UE 120 may identify the PUSCH occasion to be associated with the first PHR value (for example, to be used to calculate the first PHR value) based at least in part on comparing the SRS resource set identifiers associated with the multiple PUSCH occasions. For example, the UE 120 may identify the PUSCH occasion to be associated with the first PHR value based at least in part on the PUSCH occasion being associated with a lowest SRS resource set identifier value among the SRS resource set identifier values associated with the multiple PUSCH occasions. As another example, the UE 120 may identify the PUSCH occasion to be associated with the first PHR value based at least in part on the PUSCH occasion being associated with a highest SRS resource set identifier value among the SRS resource set identifier values associated with the multiple PUSCH occasions.

Additionally or alternatively, in accordance with the one or more rules, the PUSCH occasion may be based at least in part on TCI state identifiers associated with the multiple PUSCH occasions (for example, based at least in part on the multiple PUSCH occasions being associated with different TCI states). For example, DCI scheduling the multiple PUSCH occasions may indicate a TCI state identifier associated with a given PUSCH occasion. The UE 120 may identify the PUSCH occasion to be associated with the first PHR value (for example, to be used to calculate the first PHR value) based at least in part on comparing the TCI state identifiers associated with the multiple PUSCH occasions. For example, the UE 120 may identify the PUSCH occasion to be associated with the first PHR value based at least in part on the PUSCH occasion being associated with a lowest TCI state identifier value among the TCI state identifier values associated with the multiple PUSCH occasions. As another example, the UE 120 may identify the PUSCH occasion to be associated with the first PHR value based at least in part on the PUSCH occasion being associated with a highest TCI state identifier value among the TCI state identifier values associated with the multiple PUSCH occasions. As another example, the UE 120 may identify the PUSCH occasion to be associated with the first PHR value based at least in part on the PUSCH occasion being associated with a first TCI state mapped in the TCI field of DCI value among the multiple TCI states in the TCI field associated with the multiple PUSCH occasions.

Additionally or alternatively, in accordance with the one or more rules, the PUSCH occasion may be based at least in part on closed loop index (CLI) values associated with the multiple PUSCH occasions (for example, based at least in part on the multiple PUSCH occasions being associated with different CLI values). The UE 120 may identify the PUSCH occasion to be associated with the first PHR value (for example, to be used to calculate the first PHR value) based at least in part on comparing the CLI values associated with the multiple PUSCH occasions. For example, the UE 120 may identify the PUSCH occasion to be associated with the first PHR value based at least in part on the PUSCH occasion being associated with a lowest CLI value among the CLI values associated with the multiple PUSCH occasions. As another example, the UE 120 may identify the PUSCH occasion to be associated with the first PHR value based at least in part on the PUSCH occasion being associated with a highest CLI value among the CLI values associated with the multiple PUSCH occasions.

Additionally or alternatively, in accordance with the one or more rules, the PUSCH occasion may be based at least in part on an order of the multiple PUSCH occasions as indicated by a dynamic switching indicator or TCI states included in a DCI message that schedules the multiple PUSCH occasions. For example, the UE 120 may receive (for example, in the third operation 825) a DCI message scheduling the multiple PUSCH occasions, that includes a dynamic switching indicator or an indication of TCI states associated with the multiple PUSCH occasions. The dynamic switching indicator may also be referred to as a dynamic switching field. The dynamic switching indicator may be a two-bit field used to indicate to which TRP(s) the UE 120 is to transmit uplink communications (for example, PUSCH repetitions). For example, a dynamic switching indicator in the DCI message may indicate an order of TRPs, such as (TRP1, TRP2) or (TRP2, TRP1), for mapping TRPs to a first PUSCH occasion and a second PUSCH occasion for mTRP PUSCH repetitions. TRP1 and TRP2 may be associated with different SRS resource sets or TCI states for PUSCH occasions. If the order of TRPs as indicated by the dynamic switching indicator is (first TRP 805, second TRP 810), then the PUSCH occasion mapped to the first TRP 805 may be the first PUSCH occasion. If the order of TRPs is (second TRP 810, first TRP 805), then the PUSCH occasion mapped to the second TRP 810 may be the first PUSCH occasion. As another example, the DCI message may indicate a multiple TCI states associated with PUSCH repetitions. The UE 120 may identify the first PUSCH occasions based at least in part on the PUSCH occasion mapped to the first TCI state as indicated by an order of the multiple TCI states in the DCI message.

Additionally or alternatively, in accordance with the one or more rules, the PUSCH occasion may be based at least in part on frequency domain resource allocations associated with the multiple PUSCH occasions. For example, the multiple PUSCH occasions may be frequency division multiplexed, such that the multiple PUSCH occasions are associated with different frequency domain resources. Therefore, the UE 120 may identify that the first PUSCH occasion to be associated with the first PHR value is the PUSCH occasion, from the multiple PUSCH occasions, that is associated with a lowest frequency domain resource allocation (for example, associated with the lowest frequency domain resource allocation among frequency domain resource allocations of the multiple PUSCH occasions). As another example, the UE 120 may identify that the first PUSCH occasion to be associated with the first PHR value is the PUSCH occasion, from the multiple PUSCH occasions, that is associated with a highest frequency domain resource allocation (for example, associated with the highest frequency domain resource allocation among frequency domain resource allocations of the multiple PUSCH occasions).

Additionally or alternatively, in accordance with the one or more rules, the PUSCH occasion may be based at least in part on DMRS CDM group identifiers associated with the multiple PUSCH occasions. For example, the UE 120 may identify that the first PUSCH occasion to be associated with the first PHR value is the PUSCH occasion, from the multiple PUSCH occasions, that is associated with the lowest DMRS CDM group identifier value among DMRS CDM group identifiers associated with the multiple PUSCH occasions. As another example, the UE 120 may identify that the first PUSCH occasion to be associated with the first PHR value is the PUSCH occasion, from the multiple PUSCH occasions, that is associated with the highest DMRS CDM group identifier value among the DMRS CDM group identifiers associated with the multiple PUSCH occasions.

Additionally or alternatively, in accordance with the one or more rules, the PUSCH occasion may be based at least in part on CORESET pool index values associated with the multiple PUSCH occasions. For example, a PUSCH occasion may be associated with a CORESET pool index value (for example, corresponding to a CORESET in which DCI that scheduled the PUSCH occasion is transmitted). The UE 120 may identify that the first PUSCH occasion to be associated with the first PHR value is the PUSCH occasion, from the multiple PUSCH occasions, that is associated with the lowest CORESET pool index value among CORESET pool index values associated with the multiple PUSCH occasions. As another example, the UE 120 may identify that the first PUSCH occasion to be associated with the first PHR value is the PUSCH occasion, from the multiple PUSCH occasions, that is associated with the highest CORESET pool index value among the CORESET pool index values associated with the multiple PUSCH occasions.

In some examples, the one or more rules may be associated with one or more rule sets. For example, the one or more rule sets may be used by the UE 120 to identify a first PUSCH occasion (for example, when there are multiple PUSCH occasions sharing a common starting symbol, as described above) in different scenarios. For example, a first rule set may include a first rule that is based at least in part on the SRS resource set identifiers associated with the multiple PUSCH occasions, a second rule associated with the TCI state identifiers associated with the multiple PUSCH occasions, and a third rule associated with the CLI values associated with the multiple PUSCH occasions. The first rule set may be used by the UE 120 to identify a first PUSCH occasion (for example, when there are multiple PUSCH occasions sharing a common starting symbol, as described above) when the multiple PUSCH occasions are spatial division multiplexed mTRP PUSCH occasions, frequency division multiplexed mTRP PUSCH occasions, scheduled via single DCI-based scheduling, or scheduled via multiple DCI-based scheduling, among other examples. A second rule set may include a rule associated with an order of PUSCH occasions as indicated by a dynamic switching indicator or TCI states indicated by DCI. The second rule set may be used by the UE 120 to identify a first PUSCH occasion (for example, when there are multiple PUSCH occasions sharing a common starting symbol, as described above) when the multiple PUSCH occasions are scheduled via single DCI-based scheduling (for example, and are spatial division multiplexed mTRP PUSCH occasions or frequency division multiplexed mTRP PUSCH occasions).

A third rule set may include a rule associated the frequency domain resource allocations associated with the multiple PUSCH occasions (for example, as described in more detail elsewhere herein). The third rule set may be used by the UE 120 to identify a first PUSCH occasion (for example, when there are multiple PUSCH occasions sharing a common starting symbol, as described above) when the multiple PUSCH occasions are frequency division multiplexed (for example, and are scheduled via single DCI-based scheduling or multiple DCI-based scheduling). A fourth rule set may include a rule associated with the DMRS CDM group identifiers associated with the multiple PUSCH occasions (for example, as described in more detail elsewhere herein). The fourth rule set may be used by the UE 120 to identify a first PUSCH occasion (for example, when there are multiple PUSCH occasions sharing a common starting symbol, as described above) when the multiple PUSCH occasions are spatial division multiplexed (for example, and are scheduled via single DCI-based scheduling or multiple DCI-based scheduling). A fifth rule set may include a rule associated with the CORESET pool index values associated with the multiple PUSCH occasions (for example, as described in more detail elsewhere herein). The fifth rule set may be used by the UE 120 to identify a first PUSCH occasion (for example, when there are multiple PUSCH occasions sharing a common starting symbol, as described above) when the multiple PUSCH occasions are scheduled via multiple DCI-based scheduling.

In some aspects, the UE 120 may use a combination of the rules or rule sets described herein to identify a first PUSCH occasion (for example, when there are multiple PUSCH occasions sharing a common starting symbol, as described above). The UE 120 may calculate the first PHR using a set of power control parameters associated with the first PUSCH occasion (for example, in a similar manner as described in more detail elsewhere herein, such as in connection with FIG. 7). In some aspects, the first PHR value may be the only PHR value indicated in the PHR report, such as when the UE 120 is not capable of reporting PHR values for each TRP associated with an mTRP operation in simultaneous transmission scenarios. In such examples, the first PHR value may be the “single PHR value” described elsewhere herein.

In some other examples, the UE 120 may calculate a second PHR value. The second PHR value may be associated with a different TRP than the TRP associated with the first PHR value. For example, if the first PHR value is associated with the first TRP 805, then the second PHR value may be associated with the second TRP 810. If the first PHR value is associated with the second TRP 810, then the second PHR value may be associated with the first TRP 805. For example, if the first TRP value is an actual TRP value associated with one TRP corresponding to one PUSCH occasion among simultaneous PUSCH transmissions in an mTRP operation, then the second PHR value may also be an actual PHR value associated with another PUSCH occasion that is associated with the other TRP (for example, when the UE 120 is scheduled with mTRP communications). In other words, the UE 120 may receive scheduling information (for example, in the third operation 825) indicating that the first PUSCH occasion is associated with the first TRP 805 and a second PUSCH occasion is associated with the second TRP 810, and that the first PUSCH occasion and the second PUSCH occasion at least partially overlap in the time domain (for example, are simultaneous transmissions). The first PHR value may be associated with the first PUSCH occasion and the second PHR value may be associated with the second PUSCH occasion. For example, the UE 120 may use a second (for example, different) set of power control parameters, that are associated with the second PUSCH occasion, to calculate the second PHR value.

As another example, the first PHR value may be an actual PHR value and may be associated with one TRP, but the first PHR value may not correspond to simultaneous PUSCH transmissions in an mTRP operation. In other words, the first PHR value may be associated with a PUSCH occasion that is associated with single TRP operations. For example, the UE 120 may receive scheduling information (for example, in the third operation 825) indicating that the first PUSCH occasion is associated with the first TRP 805 and that the PUSCH occasion is associated with single TRP operations. In such examples, the first PHR value may be an actual PHR value and may be associated with the PUSCH occasion and the second PHR value may be a virtual PHR value (for example, associated with the second TRP 810). For example, the UE 120 may calculate the second PHR value using a set of default power control parameters that are associated with the second TRP 810 (for example, that are indicated via the configuration information in the second operation 820).

As another example, the first PHR value may be a virtual PHR value associated with the first TRP 805. In such examples, the second PHR value, associated with the second TRP 810, may also be a virtual PHR value. In other words, the first PHR value and the second PHR value may both be virtual PHR values. For example, if the first PHR value is a virtual PHR value, this may indicate that there is no scheduled PUSCH occasion in the slot in which the PHR report is to be transmitted. Therefore, in such examples, both the first PHR value, associated with the first TRP 805, and the second PHR value, associated with the second TRP 810, may be virtual PHR values.

In a fifth operation 835, the UE 120 may transmit the PHR report. The PHR report may be associated with the CC that is configured for simultaneous transmissions associated with mTRP operations. The UE 120 may transmit the PHR report via the CC. For example, the PHR report may be transmitted via a MAC-CE message (for example, the PHR report may be included in a MAC-CE message). The UE 120 may transmit the PHR report in the slot (for example, that is determined based at least in part on a timing of a triggering of the PHR report, as described in more detail elsewhere herein). In some aspects, the PHR report may include a single PHR value (for example, the first PHR value). In some other aspects, the PHR report may include multiple PHR values associated with multiple TRPs (for example, the first TRP value and the second TRP value).

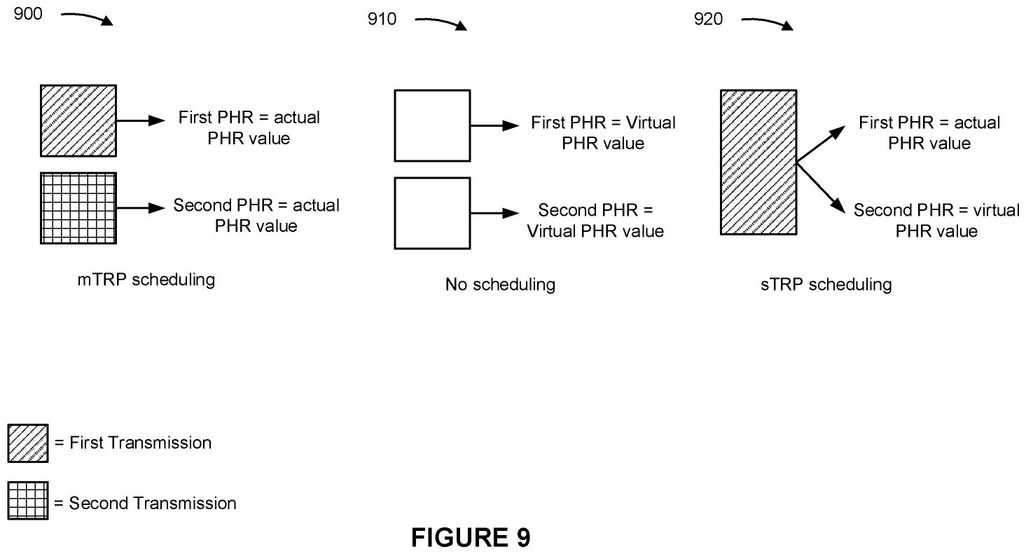

FIG. 9 is a diagram of an example associated with PUSCH occasions associated with PHR reports for mTRP scenarios with simultaneous transmissions, in accordance with the present disclosure. FIG. 9 depicts different examples of scheduling within a slot in which a PHR report is to be transmitted by a UE (for example, a UE 120) in mTRP scenarios configured for simultaneous transmissions. As shown in FIG. 9, in some cases, a CC that is configured for simultaneous transmissions associated with mTRP operations may be associated with mTRP scheduling 900. For example, in a slot in which the PHR report is to be transmitted, a first PUSCH occasion associated with a first transmission and a first TRP may be scheduled on the CC. In the same slot, a second PUSCH occasion associated with a second transmission and a second TRP may also be scheduled on the CC. The first PUSCH occasion and the second PUSCH occasion may be simultaneous transmissions (for example, may at least partially overlap in the time domain). In such examples, the UE may transmit a PHR report that include a first PHR value associated with the first PUSCH occasion and the first TRP and a second PHR value associated with the second PUSCH occasion and the second TRP. The first PHR value and the second PHR value may both be actual PHR values.

As another example, the CC that is configured for simultaneous transmissions associated with mTRP operations may be associated with no scheduling 910. In such examples, no transmissions or PUSCH occasions may be scheduled for the UE in the slot in which the UE is to transmit the PHR report. Therefore, the UE may transmit a PHR report that include a first PHR value associated with the first TRP and a second PHR value associated with the second TRP. In such examples, the first PHR value and the second PHR value are both virtual PHR values. As another example, the CC that is configured for simultaneous transmissions associated with mTRP operations may be associated with single TRP (sTRP) scheduling 920. For example, in a slot in which the PHR report is to be transmitted, a first PUSCH occasion associated with a first transmission and a first TRP may be scheduled on the CC. The first PUSCH occasion may not be associated with mTRP PUSCH repetitions or another mTRP operation (for example, the first PUSCH occasion may be associated with sTRP operations). Therefore, the UE may transmit a PHR report that include a first PHR value associated with the first PUSCH occasion and the first TRP and a second PHR value associated with the second TRP. The first PHR value may be an actual PHR value (for example, calculated based at least in part on power control parameters associated with the first PUSCH occasion or the first transmission) and the second PHR value may be a virtual PHR value (for example, calculated based at least in part on default power control parameters associated with the second TRP).

FIG. 10 is a flowchart illustrating an example process 1000 performed, for example, by a UE in accordance with the present disclosure. Example process 1000 is an example where the UE (for example, the UE 120) performs operations associated with a multiple PHR value reporting for mTRP scenarios with simultaneous transmissions.

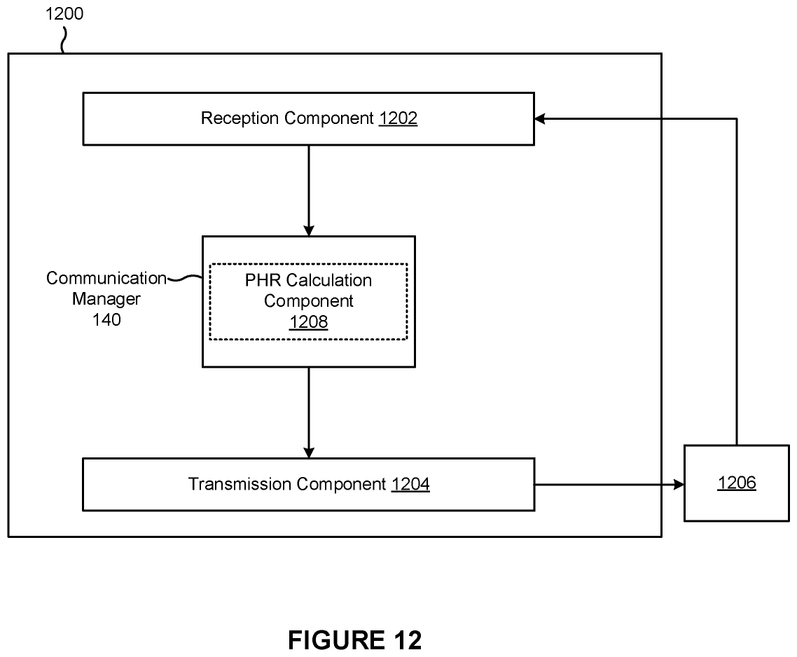

As shown in FIG. 10, in some aspects, process 1000 may include receiving a configuration for a CC configuring the CC for simultaneous transmissions associated with mTRPs (block 1010). For example, the UE (such as by using communication manager 140 or reception component 1202, depicted in FIG. 12) may receive a configuration for a CC configuring the CC for simultaneous transmissions associated with mTRPs, as described above.

As further shown in FIG. 10, in some aspects, process 1000 may include transmitting a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP (block 1020). For example, the UE (such as by using communication manager 140 or transmission component 1204, depicted in FIG. 12) may transmit a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP, as described above.

Process 1000 may include additional aspects, such as any single aspect or any combination of aspects described below or in connection with one or more other processes described elsewhere herein.

In a first additional aspect, the simultaneous transmissions include two or more transmissions that are at least partially overlapping in a time domain and at least one of: frequency division multiplexed, spatial division multiplexed, associated with single DCI based scheduling, or associated with multiple DCI based scheduling.

In a second additional aspect, alone or in combination with the first aspect, process 1000 includes transmitting a capability report indicating whether the UE is capable of transmitting PHR reports that include multiple PHR values associated with the mTRPs.

In a third additional aspect, alone or in combination with one or more of the first and second aspects, transmitting the PHR report that indicates the first PHR value and the second PHR value is based at least in part on the UE being capable of transmitting PHR reports that include multiple PHR indications associated with multiple TRPs.

In a fourth additional aspect, alone or in combination with one or more of the first through third aspects, transmitting the PHR report that indicates the single PHR value is based at least in part on the UE not being capable of transmitting PHR reports that include multiple PHR indications.

In a fifth additional aspect, alone or in combination with one or more of the first through fourth aspects, at least one of the first PHR value, the second PHR value, or the single PHR value is a virtual PHR value, and the virtual PHR value is an estimated PHR value.

In a sixth additional aspect, alone or in combination with one or more of the first through fifth aspects, transmitting the PHR report includes transmitting the PHR report in a slot, the first PHR value or the single PHR value is associated with a PUSCH occasion, and the PUSCH occasion is a first PUSCH occasion, in a time domain, that at least partially overlaps with the slot in the time domain.

In a seventh additional aspect, alone or in combination with one or more of the first through sixth aspects, the first PHR value or the single PHR value are based at least in part on one or more power control parameters associated with the PUSCH occasion.

In an eighth additional aspect, alone or in combination with one or more of the first through seventh aspects, transmitting the PHR report includes transmitting the PHR report in a slot, the slot includes multiple PUSCH occasions, that are associated with a same starting symbol, the first PHR value or the single PHR value is associated with a PUSCH occasion from the multiple PUSCH occasions, and the PUSCH occasion that is associated with the first PHR value or the single PHR value is based at least in part on one or more rules.

In a ninth additional aspect, alone or in combination with one or more of the first through eighth aspects, in accordance with the one or more rules, the PUSCH occasion is based at least in part on SRS resource set identifiers associated with the multiple PUSCH occasions.

In a tenth additional aspect, alone or in combination with one or more of the first through ninth aspects, in accordance with the one or more rules, the PUSCH occasion is based at least in part on TCI state identifiers associated with the multiple PUSCH occasions.

In an eleventh additional aspect, alone or in combination with one or more of the first through tenth aspects, in accordance with the one or more rules, the PUSCH occasion is based at least in part on closed loop index values associated with the multiple PUSCH occasions.

In a twelfth additional aspect, alone or in combination with one or more of the first through eleventh aspects, process 1000 includes receiving a DCI message, scheduling the multiple PUSCH occasions, that includes a dynamic switching indicator or TCI states associated with the multiple PUSCH occasions, and, in accordance with the one or more rules, the PUSCH occasion is based at least in part on an order of the multiple PUSCH occasions as indicated by the dynamic switching indicator or the TCI states included in the DCI message.

In a thirteenth additional aspect, alone or in combination with one or more of the first through twelfth aspects, in accordance with the one or more rules, the PUSCH occasion is based at least in part on frequency domain resource allocations associated with the multiple PUSCH occasions.

In a fourteenth additional aspect, alone or in combination with one or more of the first through thirteenth aspects, in accordance with the one or more rules, the PUSCH occasion is based at least in part on DMRS CDM group identifiers associated with the multiple PUSCH occasions.

In a fifteenth additional aspect, alone or in combination with one or more of the first through fourteenth aspects, in accordance with the one or more rules, the PUSCH occasion is based at least in part on CORESET pool index values associated with the multiple PUSCH occasions.

In a sixteenth additional aspect, alone or in combination with one or more of the first through fifteenth aspects, process 1000 includes receiving scheduling information indicating that a first PUSCH occasion is associated with the first TRP and a second PUSCH occasion is associated with the second TRP, and that the first PUSCH occasion and the second PUSCH occasion at least partially overlap in a time domain, and the first PHR value is associated with the first PUSCH occasion and the second PHR value is associated with the second PUSCH occasion.

In a seventeenth additional aspect, alone or in combination with one or more of the first through sixteenth aspects, process 1000 includes receiving scheduling information indicating that a PUSCH occasion is associated with the first TRP and that the PUSCH occasion is associated with single TRP operations, and the first PHR value is associated with the PUSCH occasion and the second PHR value is a virtual PHR value.

In an eighteenth additional aspect, alone or in combination with one or more of the first through seventeenth aspects, the first PHR value and the second PHR value are both virtual PHR values.

In a nineteenth additional aspect, alone or in combination with one or more of the first through eighteenth aspects, the PHR report is included in a MAC-CE message.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, by a network node in accordance with the present disclosure. Example process 1100 is an example where the network node (for example, base station 110, a distributed unit, a radio unit, a central unit, the first TRP 805, or the second TRP 810) performs operations associated with a multiple PHR value reporting for mTRP scenarios with simultaneous transmissions.

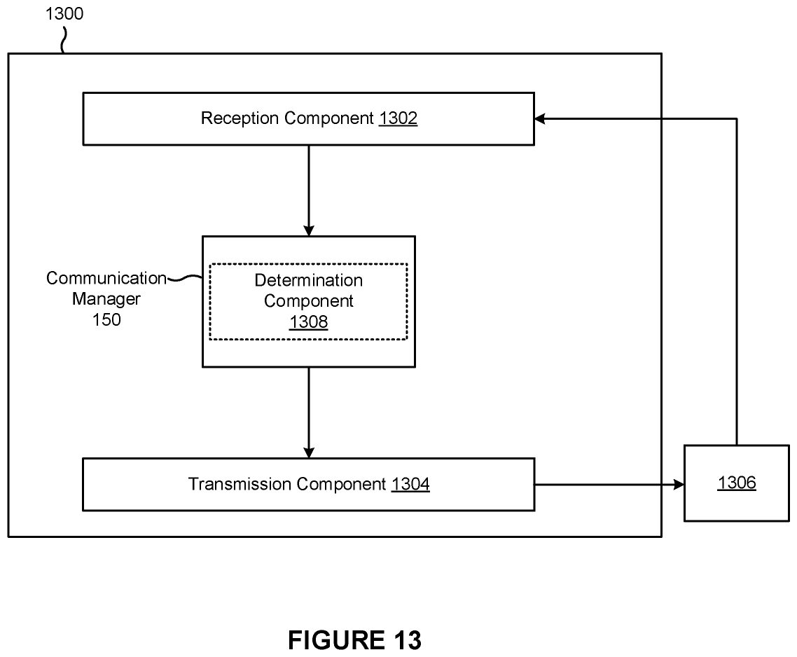

As shown in FIG. 11, in some aspects, process 1100 may include transmitting, to a UE, a configuration for a CC configuring the CC for simultaneous transmissions associated with mTRPs (block 1110). For example, the base station (such as by using communication manager 150 or transmission component 1304, depicted in FIG. 13) may transmit, to a UE, a configuration for a CC configuring the CC for simultaneous transmissions associated with mTRPs, as described above.

As further shown in FIG. 11, in some aspects, process 1100 may include receiving, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP (block 1120). For example, the base station (such as by using communication manager 150 or reception component 1302, depicted in FIG. 13) may receive, from the UE, a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP, as described above.

Process 1100 may include additional aspects, such as any single aspect or any combination of aspects described below or in connection with one or more other processes described elsewhere herein.

In a first additional aspect, the simultaneous transmissions include two or more transmissions that are at least partially overlapping in a time domain and at least one of frequency division multiplexed, spatial division multiplexed, associating with single DCI based scheduling, or associating with multiple DCI based scheduling.

In a second additional aspect, alone or in combination with the first aspect, process 1100 includes receiving, from the UE, a capability report indicating whether the UE is capable of transmitting PHR reports that include multiple PHR values associated with the mTRPs.

In a third additional aspect, alone or in combination with one or more of the first and second aspects, receiving the PHR report that indicates the first PHR value and the second PHR value is based at least in part on the UE being capable of transmitting PHR reports that include multiple PHR indications.

In a fourth additional aspect, alone or in combination with one or more of the first through third aspects, receiving the PHR report that indicates the single PHR value is based at least in part on the UE not being capable of transmitting PHR reports that include multiple PHR indications.

In a fifth additional aspect, alone or in combination with one or more of the first through fourth aspects, at least one of the first PHR value, the second PHR value, or the single PHR value is a virtual PHR value, and the virtual PHR value is an estimated PHR value.

In a sixth additional aspect, alone or in combination with one or more of the first through fifth aspects, receiving the PHR report includes receiving the PHR report in a slot, the first PHR value or the single PHR value is associated with a PUSCH occasion, and the PUSCH occasion is a first PUSCH occasion, in a time domain, that at least partially overlaps with the slot in the time domain.

In a seventh additional aspect, alone or in combination with one or more of the first through sixth aspects, the first PHR value or the single PHR value are based at least in part on one or more power control parameters associated with the PUSCH occasion.

In an eighth additional aspect, alone or in combination with one or more of the first through seventh aspects, receiving the PHR report includes receiving the PHR report in a slot, the slot includes multiple PUSCH occasions, that are associated with a same starting symbol, the first PHR value or the single PHR value is associated with a PUSCH occasion from the multiple PUSCH occasions, and the PUSCH occasion that is associated with the first PHR value or the single PHR value is based at least in part on one or more rules.

In a ninth additional aspect, alone or in combination with one or more of the first through eighth aspects, in accordance with the one or more rules, the PUSCH occasion is based at least in part on SRS resource set identifiers associated with the multiple PUSCH occasions.

In a tenth additional aspect, alone or in combination with one or more of the first through ninth aspects, in accordance with the one or more rules, the PUSCH occasion is based at least in part on TCI state identifiers associated with the multiple PUSCH occasions.

In an eleventh additional aspect, alone or in combination with one or more of the first through tenth aspects, in accordance with the one or more rules, the PUSCH occasion is based at least in part on closed loop index values associated with the multiple PUSCH occasions.

In a twelfth additional aspect, alone or in combination with one or more of the first through eleventh aspects, process 1100 includes transmitting a DCI message, scheduling the multiple PUSCH occasions, that includes a dynamic switching indicator or TCI states associated with the multiple PUSCH occasions, and, in accordance with the one or more rules, the PUSCH occasion is based at least in part on an order of the multiple PUSCH occasions as indicated by the dynamic switching indicator or the TCI states included in the DCI message.

In a thirteenth additional aspect, alone or in combination with one or more of the first through twelfth aspects, in accordance with the one or more rules, the PUSCH occasion is based at least in part on frequency domain resource allocations associated with the multiple PUSCH occasions.

In a fourteenth additional aspect, alone or in combination with one or more of the first through thirteenth aspects, in accordance with the one or more rules, the PUSCH occasion is based at least in part on DMRS CDM group identifiers associated with the multiple PUSCH occasions.

In a fifteenth additional aspect, alone or in combination with one or more of the first through fourteenth aspects, in accordance with the one or more rules, the PUSCH occasion is based at least in part on CORESET pool index values associated with the multiple PUSCH occasions.

In a sixteenth additional aspect, alone or in combination with one or more of the first through fifteenth aspects, process 1100 includes transmitting scheduling information indicating that a first PUSCH occasion is associated with the first TRP and a second PUSCH occasion is associated with the second TRP, and that the first PUSCH occasion and the second PUSCH occasion at least partially overlap in a time domain, and the first PHR value is associated with the first PUSCH occasion and the second PHR value is associated with the second PUSCH occasion.

In a seventeenth additional aspect, alone or in combination with one or more of the first through sixteenth aspects, process 1100 includes transmitting scheduling information indicating that a PUSCH occasion is associated with the first TRP and that the PUSCH occasion is associated with single TRP operations, and the first PHR value is associated with the PUSCH occasion and the second PHR value is a virtual PHR value.

In an eighteenth additional aspect, alone or in combination with one or more of the first through seventeenth aspects, the first PHR value and the second PHR value are both virtual PHR values.

In a nineteenth additional aspect, alone or in combination with one or more of the first through eighteenth aspects, the PHR report is included in a MAC-CE message.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 8 and 9. Additionally or alternatively, the apparatus 1200 may be configured to perform one or more processes described herein, such as process 1000 of FIG. 10, or a combination thereof. In some aspects, the apparatus 1200 may include one or more components of the UE described above in connection with FIG. 2.

The reception component 1202 may receive communications, such as reference signals, control information, data communications, or a combination thereof, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, a memory, or a combination thereof, of the UE described above in connection with FIG. 2.

The transmission component 1204 may transmit communications, such as reference signals, control information, data communications, or a combination thereof, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described above in connection with FIG. 2. In some aspects, the transmission component 1204 may be co-located with the reception component 1202 in a transceiver.

The communication manager 140 may receive or may cause the reception component 1202 to receive a configuration for a CC configuring the CC for simultaneous transmissions associated with mTRPs. The communication manager 140 may transmit or may cause the transmission component 1204 to transmit a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a PHR calculation component 1208, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive a configuration for a CC configuring the CC for simultaneous transmissions associated with mTRPs. The transmission component 1204 may transmit a PHR report, associated with the CC, that indicates: a first PHR value associated with a first TRP associated with the mTRPs and a second PHR value associated with a second TRP associated with the mTRPs; or a single PHR value associated with at least one of the first TRP or the second TRP.

The PHR calculation component 1208 may calculate the first PHR value and the second PHR value. In some aspects, the PHR calculation component 1208 may calculate the single PHR value. In some aspects, the PHR calculation component 1208 may calculate a PHR value based at least in part on one or more power control parameters associated with a PUSCH occasion that is associated with the PHR value. In some aspects, the PHR calculation component 1208 may calculate a virtual PHR value based at least in part on one or more default power control parameters associated with a TRP that is associated with the virtual PHR value.

The transmission component 1204 may transmit a capability report indicating whether the UE is capable of transmitting PHR reports that include multiple PHR values associated with the mTRPs.

The reception component 1202 may receive a DCI message, scheduling the multiple PUSCH occasions, that includes a dynamic switching indicator or TCI states associated with the multiple PUSCH occasions wherein, in accordance with the one or more rules, the PUSCH occasion is based at least in part on an order of the multiple PUSCH occasions as indicated by the dynamic switching indicator or the TCI states included in the DCI message.

The reception component 1202 may receive scheduling information indicating that a first PUSCH occasion is associated with the first TRP and a second PUSCH occasion is associated with the second TRP, and that the first PUSCH occasion and the second PUSCH occasion at least partially overlap in a time domain wherein the first PHR value is associated with the first PUSCH occasion and the second PHR value is associated with the second PUSCH occasion.

The reception component 1202 may receive scheduling information indicating that a PUSCH occasion is associated with the first TRP and that the PUSCH occasion is associated with single TRP operations wherein the first PHR value is associated with the PUSCH occasion and the second PHR value is a virtual PHR value.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication in accordance with the present disclosure. The apparatus 1300 may be a network node, or a network node may include the apparatus 1300. In some aspects, the apparatus 1300 may be a TRP, or a TRP may include the apparatus 1300. In some aspects, the apparatus 1300 includes a reception component 1302, a transmission component 1304, and a communication manager 150, which may be in communication with one another (for example, via one or more buses). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 8 and 9. Additionally or alternatively, the apparatus 1300 may be configured to perform one or more processes described herein, such as process 1100 of FIG. 11, or a combination thereof. In some aspects, the apparatus 1300 may include one or more components of the base station described above in connection with FIG. 2.

The reception component 1302 may receive communications, such as reference signals, control information, data communications, or a combination thereof, from the apparatus 1306. The reception component 1302 may provide received communications to one or more other components of the apparatus 1300, such as the communication manager 150. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, a memory, or a combination thereof, of the base station described above in connection with FIG. 2.

The transmission component 1304 may transmit communications, such as reference signals, control information, data communications, or a combination thereof, to the apparatus 1306. In some aspects, the communication manager 150 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station described above in connection with FIG. 2. In some aspects, the transmission component 1304 may be co-located with the reception component 1302 in a transceiver.

The communication manager 150 may transmit or may cause the transmission component 1304 to transmit, to a UE, a configuration for a CC configuring the CC for simultaneous transmissions associated with mTRPs. The communication manager 150 may receive or may cause the reception component 1302 to receive, from the UE, a PHR report, associated with the CC, that indicates a first PHR value associated with a first TRP associated with the mTRPs and a second PHR value associated with a second TRP associated with the mTRPs; or a single PHR value associated with at least one of the first TRP or the second TRP. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the base station described above in connection with FIG. 2. In some aspects, the communication manager 150 includes a set of components, such as a determination component 1308, or a combination thereof. Alternatively, the set of components may be separate and distinct from the communication manager 150. In some aspects, one or more components of the set of components may include or may be implemented within a controller/processor, a memory, a scheduler, a communication unit, or a combination thereof, of the base station described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1304 may transmit, to a UE, a configuration for a CC configuring the CC for simultaneous transmissions associated with mTRPs. The reception component 1302 may receive, from the UE, a PHR report, associated with the CC, that indicates a first PHR value associated with a first TRP associated with the mTRPs and a second PHR value associated with a second TRP associated with the mTRPs; or a single PHR value associated with at least one of the first TRP or the second TRP.

The transmission component 1304 may transmit, to a UE, configuration information that indicates whether the PHR report is to include multiple PHR values associated with the mTRPs, or a single PHR value associated with a single TRP of the mTRPs. The determination component 1308 may determine the configuration information. In some aspects, the determination component 1308 may determine the configuration information based at least in part on a capability of the UE.

The reception component 1302 may receive, from the UE, a capability report indicating whether the UE is capable of transmitting PHR reports that include multiple PHR values associated with the mTRPs.

The transmission component 1304 may transmit a DCI message, scheduling the multiple PUSCH occasions, that includes a dynamic switching indicator or TCI states associated with the multiple PUSCH occasions wherein, in accordance with the one or more rules, the PUSCH occasion is based at least in part on an order of the multiple PUSCH occasions as indicated by the dynamic switching indicator or the TCI states included in the DCI message.

The transmission component 1304 may transmit scheduling information indicating that a first PUSCH occasion is associated with the first TRP and a second PUSCH occasion is associated with the second TRP, and that the first PUSCH occasion and the second PUSCH occasion at least partially overlap in a time domain wherein the first PHR value is associated with the first PUSCH occasion and the second PHR value is associated with the second PUSCH occasion.

The transmission component 1304 may transmit scheduling information indicating that a PUSCH occasion is associated with the first TRP and that the PUSCH occasion is associated with single TRP operations wherein the first PHR value is associated with the PUSCH occasion and the second PHR value is a virtual PHR value.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a configuration for a component carrier (CC) configuring the CC for simultaneous transmissions associated with multiple transmission reception points (TRPs); and transmitting a power headroom (PHR) report, associated with the CC, that indicates: a first PHR value associated with a first TRP associated with the multiple TRPs (mTRPs) and a second PHR value associated with a second TRP associated with the mTRPs; or a single PHR value associated with at least one of the first TRP or the second TRP.

Aspect 2: The method of Aspect 1, wherein the simultaneous transmissions include two or more transmissions that are at least partially overlapping in a time domain and at least one of: frequency division multiplexed, spatial division multiplexed, associated with single downlink control information (DCI) based scheduling, or associated with multiple DCI based scheduling.

Aspect 3: The method of any of Aspects 1-2, further comprising transmitting a capability report indicating whether the UE is capable of transmitting PHR reports that include multiple PHR values associated with the mTRPs.

Aspect 4: The method of Aspect 3, wherein transmitting the PHR report that indicates the first PHR value and the second PHR value is based at least in part on the UE being capable of transmitting PHR reports that include multiple PHR indications associated with multiple TRPs.

Aspect 5: The method of Aspect 3, wherein transmitting the PHR report that indicates the single PHR value is based at least in part on the UE not being capable of transmitting PHR reports that include multiple PHR indications.

Aspect 6: The method of any of Aspects 1-5, wherein at least one of the first PHR value, the second PHR value, or the single PHR value is a virtual PHR value, and wherein the virtual PHR value is an estimated PHR value.

Aspect 7: The method of any of Aspects 1-6, wherein transmitting the PHR report comprises transmitting the PHR report in a slot, wherein the first PHR value or the single PHR value is associated with a physical uplink shared channel (PUSCH) occasion, and wherein the PUSCH occasion is a first PUSCH occasion, in a time domain, that at least partially overlaps with the slot in the time domain.

Aspect 8: The method of Aspect 7, wherein the first PHR value or the single PHR value are based at least in part on one or more power control parameters associated with the PUSCH occasion.

Aspect 9: The method of any of Aspects 1-8, wherein transmitting the PHR report comprises transmitting the PHR report in a slot, wherein the slot includes multiple physical uplink shared channel (PUSCH) occasions, that are associated with a same starting symbol, wherein the first PHR value or the single PHR value is associated with a PUSCH occasion from the multiple PUSCH occasions, and wherein the PUSCH occasion that is associated with the first PHR value or the single PHR value is based at least in part on one or more rules.

Aspect 10: The method of Aspect 9, wherein, in accordance with the one or more rules, the PUSCH occasion is based at least in part on sounding reference signal (SRS) resource set identifiers associated with the multiple PUSCH occasions.

Aspect 11: The method of any of Aspects 9-10, wherein, in accordance with the one or more rules, the PUSCH occasion is based at least in part on transmission configuration indicator (TCI) state identifiers associated with the multiple PUSCH occasions.

Aspect 12: The method of any of Aspects 9-11, wherein, in accordance with the one or more rules, the PUSCH occasion is based at least in part on closed loop index values associated with the multiple PUSCH occasions.

Aspect 13: The method of any of Aspects 9-12, further comprising receiving a downlink control information (DCI) message, scheduling the multiple PUSCH occasions, that includes a dynamic switching indicator or transmission configuration indicator (TCI) states associated with the multiple PUSCH occasions, and wherein, in accordance with the one or more rules, the PUSCH occasion is based at least in part on an order of the multiple PUSCH occasions as indicated by the dynamic switching indicator or the TCI states included in the DCI message.

Aspect 14: The method of any of Aspects 9-13, wherein, in accordance with the one or more rules, the PUSCH occasion is based at least in part on frequency domain resource allocations associated with the multiple PUSCH occasions.

Aspect 15: The method of any of Aspects 9-14, wherein, in accordance with the one or more rules, the PUSCH occasion is based at least in part on demodulation reference signal (DMRS) code division multiplex (CDM) group identifiers associated with the multiple PUSCH occasions.

Aspect 16: The method of any of Aspects 9-15, wherein, in accordance with the one or more rules, the PUSCH occasion is based at least in part on control resource set (CORESET) pool index values associated with the multiple PUSCH occasions.

Aspect 17: The method of any of Aspects 1-16, further comprising receiving scheduling information indicating that a first physical uplink shared channel (PUSCH) occasion is associated with the first TRP and a second PUSCH occasion is associated with the second TRP, and that the first PUSCH occasion and the second PUSCH occasion at least partially overlap in a time domain, and wherein the first PHR value is associated with the first PUSCH occasion and the second PHR value is associated with the second PUSCH occasion.

Aspect 18: The method of any of Aspects 1-16, further comprising receiving scheduling information indicating that a physical uplink shared channel (PUSCH) occasion is associated with the first TRP and that the PUSCH occasion is associated with single TRP operations, and wherein the first PHR value is associated with the PUSCH occasion and the second PHR value is a virtual PHR value.

Aspect 19: The method of any of Aspects 1-16, wherein the first PHR value and the second PHR value are both virtual PHR values.

Aspect 20: The method of any of Aspects 1-19, wherein the PHR report is included in a medium access control (MAC) control element (MAC-CE) message.

Aspect 21: A method of wireless communication performed by a network node, comprising: transmitting, to a user equipment (UE), a configuration for a component carrier (CC) configuring the CC for simultaneous transmissions associated with multiple transmission reception points (TRPs); and receiving, from the UE, a power headroom (PHR) report, associated with the CC, that indicates: a first PHR value associated with a first TRP associated with the multiple TRPs (mTRPs) and a second PHR value associated with a second TRP associated with the mTRPs; or a single PHR value associated with at least one of the first TRP or the second TRP.

Aspect 22: The method of Aspect 21, wherein the simultaneous transmissions include two or more transmissions that are at least partially overlapping in a time domain and at least one of: frequency division multiplexed, spatial division multiplexed, associated with single downlink control information (DCI) based scheduling, or associated with multiple DCI based scheduling.

Aspect 23: The method of any of Aspects 21-22, further comprising receiving, from the UE, a capability report indicating whether the UE is capable of transmitting PHR reports that include multiple PHR values associated with the mTRPs.

Aspect 24: The method of Aspect 23, wherein receiving the PHR report that indicates the first PHR value and the second PHR value is based at least in part on the UE being capable of transmitting PHR reports that include multiple PHR indications.

Aspect 25: The method of Aspect 23, wherein receiving the PHR report that indicates the single PHR value is based at least in part on the UE not being capable of transmitting PHR reports that include multiple PHR indications.

Aspect 26: The method of any of Aspects 21-25, wherein at least one of the first PHR value, the second PHR value, or the single PHR value is a virtual PHR value, and wherein the virtual PHR value is an estimated PHR value.

Aspect 27: The method of any of Aspects 21-26, wherein receiving the PHR report comprises receiving the PHR report in a slot, wherein the first PHR value or the single PHR value is associated with a physical uplink shared channel (PUSCH) occasion, and wherein the PUSCH occasion is a first PUSCH occasion, in a time domain, that at least partially overlaps with the slot in the time domain.

Aspect 28: The method of Aspect 27, wherein the first PHR value or the single PHR value are based at least in part on one or more power control parameters associated with the PUSCH occasion.

Aspect 29: The method of any of Aspects 21-28, wherein receiving the PHR report comprises receiving the PHR report in a slot, wherein the slot includes multiple physical uplink shared channel (PUSCH) occasions, that are associated with a same starting symbol, wherein the first PHR value or the single PHR value is associated with a PUSCH occasion from the multiple PUSCH occasions, and wherein the PUSCH occasion that is associated with the first PHR value or the single PHR value is based at least in part on one or more rules.

Aspect 30: The method of Aspect 29, wherein, in accordance with the one or more rules, the PUSCH occasion is based at least in part on sounding reference signal (SRS) resource set identifiers associated with the multiple PUSCH occasions.

Aspect 31: The method of any of Aspects 29-30, wherein, in accordance with the one or more rules, the PUSCH occasion is based at least in part on transmission configuration indicator (TCI) state identifiers associated with the multiple PUSCH occasions.

Aspect 32: The method of any of Aspects 29-31, wherein, in accordance with the one or more rules, the PUSCH occasion is based at least in part on closed loop index values associated with the multiple PUSCH occasions.

Aspect 33: The method of any of Aspects 29-32, further comprising transmitting a downlink control information (DCI) message, scheduling the multiple PUSCH occasions, that includes a dynamic switching indicator or transmission configuration indicator (TCI) states associated with the multiple PUSCH occasions, and wherein, in accordance with the one or more rules, the PUSCH occasion is based at least in part on an order of the multiple PUSCH occasions as indicated by the dynamic switching indicator or the TCI states included in the DCI message.

Aspect 34: The method of any of Aspects 29-33, wherein, in accordance with the one or more rules, the PUSCH occasion is based at least in part on frequency domain resource allocations associated with the multiple PUSCH occasions.

Aspect 35: The method of any of Aspects 29-34, wherein, in accordance with the one or more rules, the PUSCH occasion is based at least in part on demodulation reference signal (DMRS) code division multiplex (CDM) group identifiers associated with the multiple PUSCH occasions.

Aspect 36: The method of any of Aspects 29-35, wherein, in accordance with the one or more rules, the PUSCH occasion is based at least in part on control resource set (CORESET) pool index values associated with the multiple PUSCH occasions.

Aspect 37: The method of any of Aspects 21-36, further comprising transmitting scheduling information indicating that a first physical uplink shared channel (PUSCH) occasion is associated with the first TRP and a second PUSCH occasion is associated with the second TRP, and that the first PUSCH occasion and the second PUSCH occasion at least partially overlap in a time domain, and wherein the first PHR value is associated with the first PUSCH occasion and the second PHR value is associated with the second PUSCH occasion.

Aspect 38: The method of any of Aspects 21-36, further comprising transmitting scheduling information indicating that a physical uplink shared channel (PUSCH) occasion is associated with the first TRP and that the PUSCH occasion is associated with single TRP operations, and wherein the first PHR value is associated with the PUSCH occasion and the second PHR value is a virtual PHR value.

Aspect 39: The method of any of Aspects 21-36, wherein the first PHR value and the second PHR value are both virtual PHR values.

Aspect 40: The method of any of Aspects 21-39, wherein the PHR report is included in a medium access control (MAC) control element (MAC-CE) message.

Aspect 41: An apparatus for wireless communication at a device, comprising a processor; memory coupled with the processor; and instructions stored in the memory and executable by the processor to cause the apparatus to perform the method of one or more of Aspects 1-20.

Aspect 42: A device for wireless communication, comprising a memory and one or more processors coupled to the memory, the one or more processors configured to perform the method of one or more of Aspects 1-20.

Aspect 43: An apparatus for wireless communication, comprising at least one means for performing the method of one or more of Aspects 1-20.

Aspect 44: A non-transitory computer-readable medium storing code for wireless communication, the code comprising instructions executable by a processor to perform the method of one or more of Aspects 1-20.

Aspect 45: A non-transitory computer-readable medium storing a set of instructions for wireless communication, the set of instructions comprising one or more instructions that, when executed by one or more processors of a device, cause the device to perform the method of one or more of Aspects 1-20.

Aspect 46: An apparatus for wireless communication at a device, comprising a processor; memory coupled with the processor; and instructions stored in the memory and executable by the processor to cause the apparatus to perform the method of one or more of Aspects 21-40.

Aspect 47: A device for wireless communication, comprising a memory and one or more processors coupled to the memory, the one or more processors configured to perform the method of one or more of Aspects 21-40.

Aspect 48: An apparatus for wireless communication, comprising at least one means for performing the method of one or more of Aspects 21-40.

Aspect 49: A non-transitory computer-readable medium storing code for wireless communication, the code comprising instructions executable by a processor to perform the method of one or more of Aspects 21-40.

Aspect 50: A non-transitory computer-readable medium storing a set of instructions for wireless communication, the set of instructions comprising one or more instructions that, when executed by one or more processors of a device, cause the device to perform the method of one or more of Aspects 21-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor; and
at least one memory communicatively coupled with the at least one processor and storing processor-readable code that, when executed by the at least one processor, is configured to cause the UE to:
receive a configuration for a component carrier (CC) configuring the CC for simultaneous transmissions associated with multiple transmission reception points (TRPs); and
transmit a power headroom (PHR) report, associated with the CC, that indicates:
a first PHR value associated with a first TRP associated with the multiple TRPs (mTRPs) and a second PHR value associated with a second TRP associated with the mTRPs; or
a single PHR value associated with at least one of the first TRP or the second TRP.

2. The UE of claim 1, wherein the simultaneous transmissions include two or more transmissions that are at least partially overlapping in a time domain and at least one of:
frequency division multiplexed,
spatial division multiplexed,
associated with single downlink control information (DCI) based scheduling, or
associated with multiple DCI based scheduling.

3. The UE of claim 1, wherein the at least one memory further stores processor-readable code configured to cause the UE to transmit a capability report indicating whether the UE is capable of transmitting PHR reports that include multiple PHR values associated with the mTRPs.

4. The UE of claim 1, wherein at least one of the first PHR value, the second PHR value, or the single PHR value is a virtual PHR value, and wherein the virtual PHR value is an estimated PHR value.

5. The UE of claim 1, wherein transmitting the PHR report comprises transmitting the PHR report in a slot, wherein the first PHR value or the single PHR value is associated with a physical uplink shared channel (PUSCH) occasion, and wherein the PUSCH occasion is a first PUSCH occasion, in a time domain, that at least partially overlaps with the slot in the time domain.

6. The UE of claim 1, wherein transmitting the PHR report comprises transmitting the PHR report in a slot, wherein the slot includes multiple physical uplink shared channel (PUSCH) occasions, that are associated with a same starting symbol, wherein the first PHR value or the single PHR value is associated with a PUSCH occasion from the multiple PUSCH occasions, and wherein the PUSCH occasion that is associated with the first PHR value or the single PHR value is based at least in part on one or more rules.

7. The UE of claim 6, wherein, in accordance with the one or more rules, the PUSCH occasion is based at least in part on at least one of:
sounding reference signal (SRS) resource set identifiers associated with the multiple PUSCH occasions;
transmission configuration indicator (TCI) state identifiers associated with the multiple PUSCH occasions; or
closed loop index values associated with the multiple PUSCH occasions.

8. The UE of claim 6, wherein the at least one memory further stores processor-readable code configured to cause the UE to receive a downlink control information (DCI) message, scheduling the multiple PUSCH occasions, that includes a dynamic switching indicator or transmission configuration indicator (TCI) states associated with the multiple PUSCH occasions, and
wherein, in accordance with the one or more rules, the PUSCH occasion is based at least in part on an order of the multiple PUSCH occasions as indicated by the dynamic switching indicator or the TCI states included in the DCI message.

9. The UE of claim 1, wherein the at least one memory further stores processor-readable code configured to cause the UE to receive scheduling information indicating that a first physical uplink shared channel (PUSCH) occasion is associated with the first TRP and a second PUSCH occasion is associated with the second TRP, and that the first PUSCH occasion and the second PUSCH occasion at least partially overlap in a time domain, and
wherein the first PHR value is associated with the first PUSCH occasion and the second PHR value is associated with the second PUSCH occasion.

10. The UE of claim 1, wherein the at least one memory further stores processor-readable code configured to cause the UE to receive scheduling information indicating that a physical uplink shared channel (PUSCH) occasion is associated with the first TRP and that the PUSCH occasion is associated with single TRP operations, and
wherein the first PHR value is associated with the PUSCH occasion and the second PHR value is a virtual PHR value.

11. The UE of claim 1, wherein the first PHR value and the second PHR value are both virtual PHR values.

12. A network node for wireless communication, comprising:
at least one processor; and
at least one memory communicatively coupled with the at least one processor and storing processor-readable code that, when executed by the at least one processor, is configured to cause the network node to:
transmit, to a user equipment (UE), a configuration for a component carrier (CC) configuring the CC for simultaneous transmissions associated with multiple transmission reception points (TRPs); and
receive, from the UE, a power headroom (PHR) report, associated with the CC, that indicates:
a first PHR value associated with a first TRP associated with the multiple TRP (mTRPs) and a second PHR value associated with a second TRP associated with the mTRPs; or
a single PHR value associated with at least one of the first TRP or the second TRP.

13. The network node of claim 12, wherein receiving the PHR report comprises receiving the PHR report in a slot, wherein the slot includes multiple physical uplink shared channel (PUSCH) occasions, that are associated with a same starting symbol, wherein the first PHR value or the single PHR value is associated with a PUSCH occasion from the multiple PUSCH occasions, and wherein the PUSCH occasion that is associated with the first PHR value or the single PHR value is based at least in part on one or more rules.

14. The network node of claim 13, wherein, in accordance with the one or more rules, the PUSCH occasion is based at least in part on sounding reference signal (SRS) resource set identifiers associated with the multiple PUSCH occasions.

15. The network node of claim 13, wherein, in accordance with the one or more rules, the PUSCH occasion is based at least in part on transmission configuration indicator (TCI) state identifiers associated with the multiple PUSCH occasions.

16. The network node of claim 13, wherein, in accordance with the one or more rules, the PUSCH occasion is based at least in part on closed loop index values associated with the multiple PUSCH occasions.

17. The network node of claim 12, wherein the at least one memory further stores processor-readable code configured to cause the network node to transmit scheduling information indicating that a first physical uplink shared channel (PUSCH) occasion is associated with the first TRP and a second PUSCH occasion is associated with the second TRP, and that the first PUSCH occasion and the second PUSCH occasion at least partially overlap in a time domain, and
wherein the first PHR value is associated with the first PUSCH occasion and the second PHR value is associated with the second PUSCH occasion.

18. A method of wireless communication performed by a user equipment (UE), comprising:
receiving a configuration for a component carrier (CC) configuring the CC for simultaneous transmissions associated with multiple transmission reception points (TRPs); and
transmitting a power headroom (PHR) report, associated with the CC, that indicates:
a first PHR value associated with a first TRP associated with the multiple TRP (mTRPs) and a second PHR value associated with a second TRP associated with the mTRPs; or
a single PHR value associated with at least one of the first TRP or the second TRP.

19. The method of claim 18, wherein the simultaneous transmissions include two or more transmissions that are at least partially overlapping in a time domain and at least one of:
frequency division multiplexed,
spatial division multiplexed,
associated with single downlink control information (DCI) based scheduling, or
associated with multiple DCI based scheduling.

20. The method of claim 18, further comprising transmitting a capability report indicating whether the UE is capable of transmitting PHR reports that include multiple PHR values associated with the mTRPs.

21. The method of claim 20, wherein PHR report indicates the first PHR value and the second PHR value is based at least in part on the UE being capable of transmitting PHR reports that include multiple PHR indications associated with multiple TRPs or indicates the single PHR value is based at least in part on the UE not being capable of transmitting PHR reports that include multiple PHR indications.

22. The method of claim 18, wherein transmitting the PHR report comprises transmitting the PHR report in a slot, wherein the first PHR value or the single PHR value is associated with a physical uplink shared channel (PUSCH) occasion, and wherein the PUSCH occasion is a first PUSCH occasion, in a time domain, that at least partially overlaps with the slot in the time domain.

23. The method of claim 18, wherein transmitting the PHR report comprises transmitting the PHR report in a slot, wherein the slot includes multiple physical uplink shared channel (PUSCH) occasions, that are associated with a same starting symbol, wherein the first PHR value or the single PHR value is associated with a PUSCH occasion from the multiple PUSCH occasions, and wherein the PUSCH occasion that is associated with the first PHR value or the single PHR value is based at least in part on one or more rules.

24. The method of claim 23, further comprising receiving a downlink control information (DCI) message, scheduling the multiple PUSCH occasions, that includes a dynamic switching indicator or transmission configuration indicator (TCI) states associated with the multiple PUSCH occasions, and
wherein, in accordance with the one or more rules, the PUSCH occasion is based at least in part on an order of the multiple PUSCH occasions as indicated by the dynamic switching indicator or the TCI states included in the DCI message.

25. The method of claim 23, wherein, in accordance with the one or more rules, the PUSCH occasion is based at least in part on at least one of:
frequency domain resource allocations associated with the multiple PUSCH occasions;
demodulation reference signal (DMRS) code division multiplex (CDM) group identifiers associated with the multiple PUSCH occasions; or
control resource set (CORESET) pool index values associated with the multiple PUSCH occasions.

26. A method of wireless communication performed by a network node, comprising:
transmitting, to a user equipment (UE), a configuration for a component carrier (CC) configuring the CC for simultaneous transmissions associated with multiple transmission reception points (TRPs); and
receiving, from the UE, a power headroom (PHR) report, associated with the CC, that indicates:
a first PHR value associated with a first TRP associated with the multiple TRPs (mTRPs) and a second PHR value associated with a second TRP associated with the mTRPs; or
a single PHR value associated with at least one of the first TRP or the second TRP.

27. The method of claim 26, wherein receiving the PHR report comprises receiving the PHR report in a slot, wherein the slot includes multiple physical uplink shared channel (PUSCH) occasions, that are associated with a same starting symbol, wherein the first PHR value or the single PHR value is associated with a PUSCH occasion from the multiple PUSCH occasions, and wherein the PUSCH occasion that is associated with the first PHR value or the single PHR value is based at least in part on one or more rules.

28. The method of claim 27, wherein, in accordance with the one or more rules, the PUSCH occasion is based at least in part on frequency domain resource allocations associated with the multiple PUSCH occasions.

29. The method of claim 27, wherein, in accordance with the one or more rules, the PUSCH occasion is based at least in part on demodulation reference signal (DMRS) code division multiplex (CDM) group identifiers associated with the multiple PUSCH occasions.

30. The method of claim 27, wherein, in accordance with the one or more rules, the PUSCH occasion is based at least in part on control resource set (CORESET) pool index values associated with the multiple PUSCH occasions.
